(19) United States
(12) Patent Application Publication
(10) Pub. No.: US 2017/0329208 A1
(43) Pub. Date: Nov. 16, 2017

(54) INFORMATION PROCESSING APPARATUS AND METHOD

(71) Applicant: SONY CORPORATION, TOKYO (JP)

(72) Inventor: NAOMASA TAKAHASHI, CHIBA (JP)

(21) Appl. No.: 15/531,860

(22) PCT Filed: Dec. 3, 2015
(86) PCT No.: PCT/JP2015/083960

§ 371 Date: May 31, 2017

(30) Foreign Application Priority Data
Dec. 17, 2014 (JP) 2014-255294

(51) Int. Cl. G03B 21/12; H04N 5/66; G09G 5/377

(52) U.S. Cl. CPC G03B 21/12; H04N 5/66; G09G 5/377

(57) ABSTRACT

The present technology relates to an information processing apparatus and method that enable characteristics of a projection image to be varied locally. An information processing apparatus according to the present technology controls a first projection unit to project a first image onto an image projection surface and controls a second projection unit to project a second image in an attention area as a predetermined partial area of the first image projected onto the image projection surface by the first projection unit. The present technology is applicable to electronic apparatuses including a projector function or both the projector function and a camera function, a computer that controls the electronic apparatuses, and the like.

### TECHNICAL FIELD

The present technology relates to an information processing apparatus and method, more particularly, to an information processing apparatus and method that enable projection image characteristics to be varied locally.

### BACKGROUND ART

From the past, there has been a system that projects images using a plurality of projectors (see, for example, Non-Patent Literature 1). In such a system, a computer controls the plurality of projectors to cooperate with one another to correct individual differences and relative positions of the projectors and project one large image having uniform image characteristics.

### CITATION LIST

### Non-Patent Literature

Non-Patent Literature 1: Ramesh Raskar, Jeroen van Baar, Paul Beardsley, Thomas Willwacher, Srinivas Rao, Clifton Forlines, “iLamps: Geometrically Aware and Self-Configuring Projectors”, ACM SIGGRAPH 2003 Conference Proceedings

### DISCLOSURE OF INVENTION

### Technical Problem

However, there is a rising demand for expressiveness of projection images projected by projectors. For example, projection images in which image characteristics such as luminance and resolution are not uniform are being demanded, and there has been a fear that such projection images cannot be realized with the system of the past.

The present technology has been proposed in view of the circumstances as described above and aims at enabling projection image characteristics to be varied locally.

### Solution to Problem

According to an aspect of the present technology, there is provided an information processing apparatus including a control unit that controls a first projection unit to project a first image onto an image projection surface and controls a second projection unit to project the second image in an attention area as a predetermined partial area of the first image projected onto the image projection surface by the first projection unit.

The control unit is capable of causing a partial image projected in the attention area of the first image or an image obtained by changing parameters of the partial image, to be projected as the second image in the attention area.

The control unit is capable of causing an image having a picture different from that of a partial image projected in the attention area of the first image, to be projected as the second image in the attention area.

The information processing apparatus is capable of further including an attention area setting unit that sets the attention area, and the control unit is capable of controlling a direction and angle of view of the projection of the second projection unit to cause the second image to be projected in the attention area set by the attention area setting unit.

The attention area setting unit is capable of setting the attention area on the basis of predetermined image characteristics.

The attention area setting unit is capable of setting, as the attention area, an area where a characteristic parameter with respect to the first image is within a desired range.

The attention area setting unit is capable of setting, as the attention area, an area including an object whose distance from the first image in a depth direction is within a desired range.

The attention area setting unit is capable of setting an area where a feature is detected with respect to the first image as the attention area.

The attention area setting unit is capable of setting an area including an object with respect to the first image as the attention area.

The attention area setting unit is capable of setting an area designated with respect to the first image as the attention area.

The control unit is capable of controlling the direction and angle of view of the projection of the second projection unit on the basis of a captured image obtained by an image pickup unit capturing the first image and the second image projected onto the image projection surface.

The first projection unit and the second projection unit are capable of being driven in sync with synchronization signals that are independent from each other, and the control unit is capable of causing the first image and the second image to be projected at a timing where the synchronization signals of all the projection units match.

The information processing apparatus is capable of further including an attention area setting unit that sets the attention area, the first projection unit and the second projection unit are capable of being driven in sync with synchronization signals that are independent from each other, and the control unit is capable of controlling an image pickup unit to capture the first image and the second image projected onto the image projection surface in sync with the synchronization signals and controlling a direction and angle of view of the projection of the second projection unit on the basis of the captured image, to cause the second image to be projected in the attention area set by the attention area setting unit.

The information processing apparatus is capable of further including the first projection unit and the second projection unit.

A relative position between the first projection unit and the second projection unit can be fixed.

The information processing apparatus is capable of further including an image pickup unit that captures the first image and the second image projected onto the image projection surface.

The first projection unit, the second projection unit, the image pickup unit, and the control unit can be formed integrally.

The first projection unit and the second projection unit can be arranged in a periphery of the image pickup unit.

The image pickup unit can be provided plurally.

According to an aspect of the present technology, there is provided an information processing method including: controlling a first projection unit to project a first image onto an image projection surface; and controlling a second projection unit to project the second image in an attention area as a predetermined partial area of the first image projected onto the image projection surface by the first projection unit.

According to the aspect of the present technology, the first projection unit is controlled so that the first image is projected onto the image projection surface, and the second projection unit is controlled so that the second image is projected in the attention area as a predetermined partial area of the first image projected onto the image projection surface by the first projection unit.

### Advantageous Effects of Invention

According to the present technology, information can be processed. In addition, according to the present technology, projection image characteristics can be varied locally.

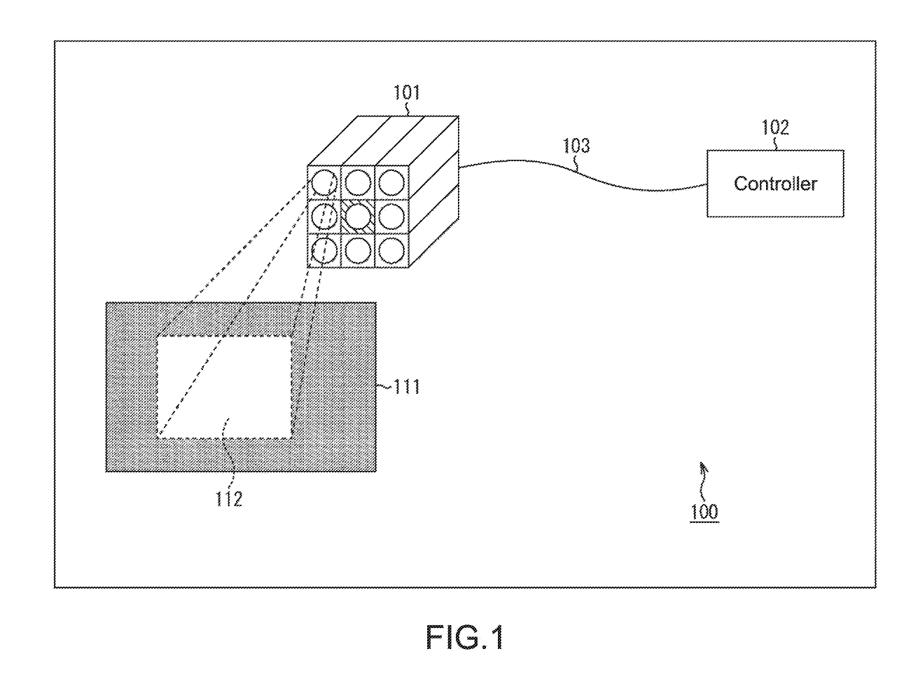

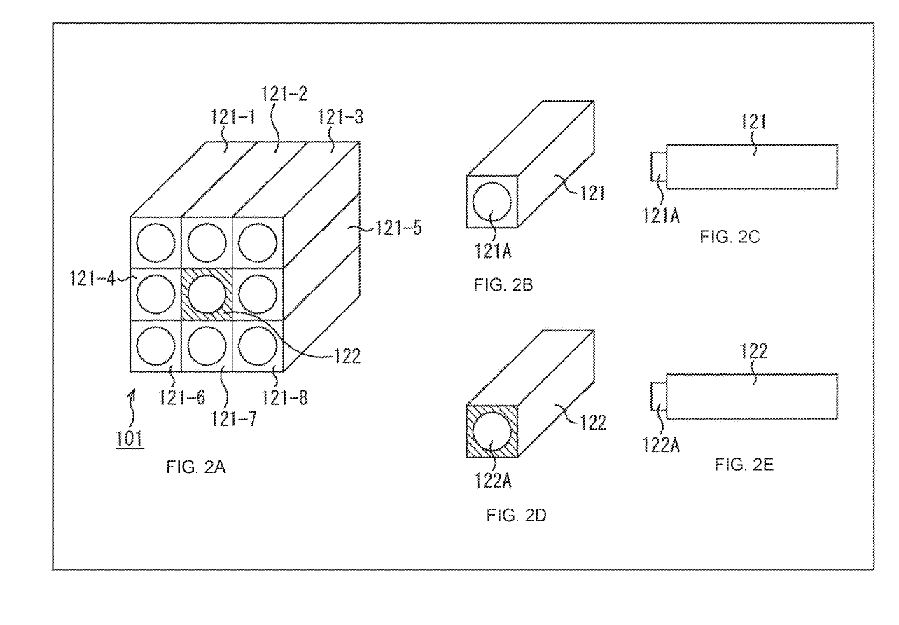

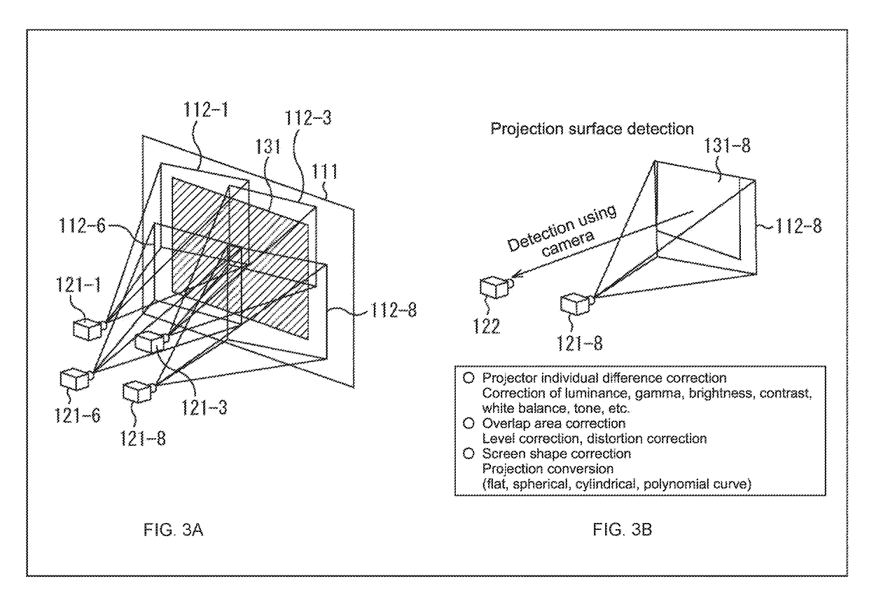

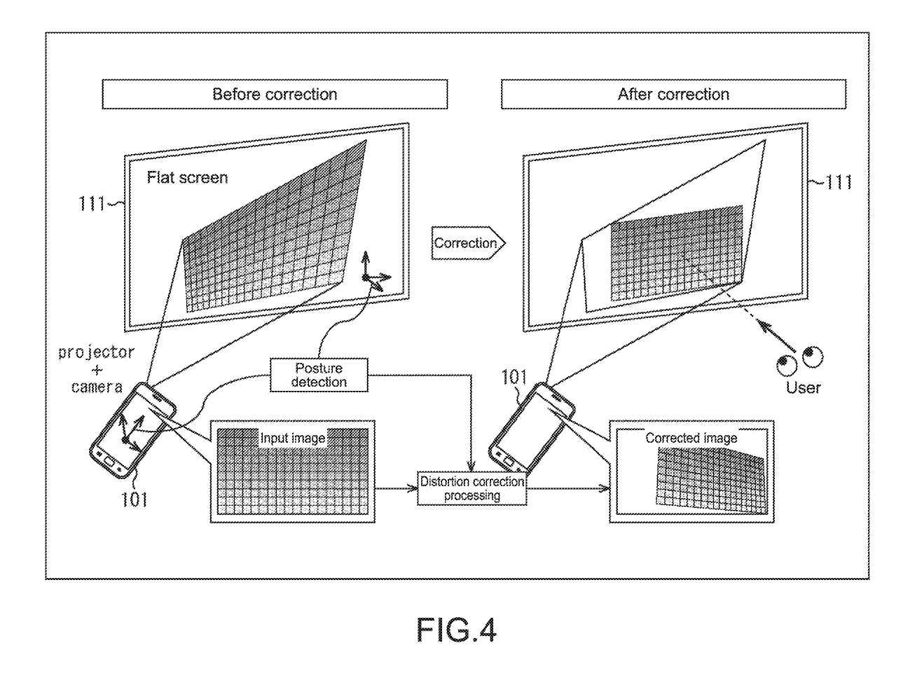

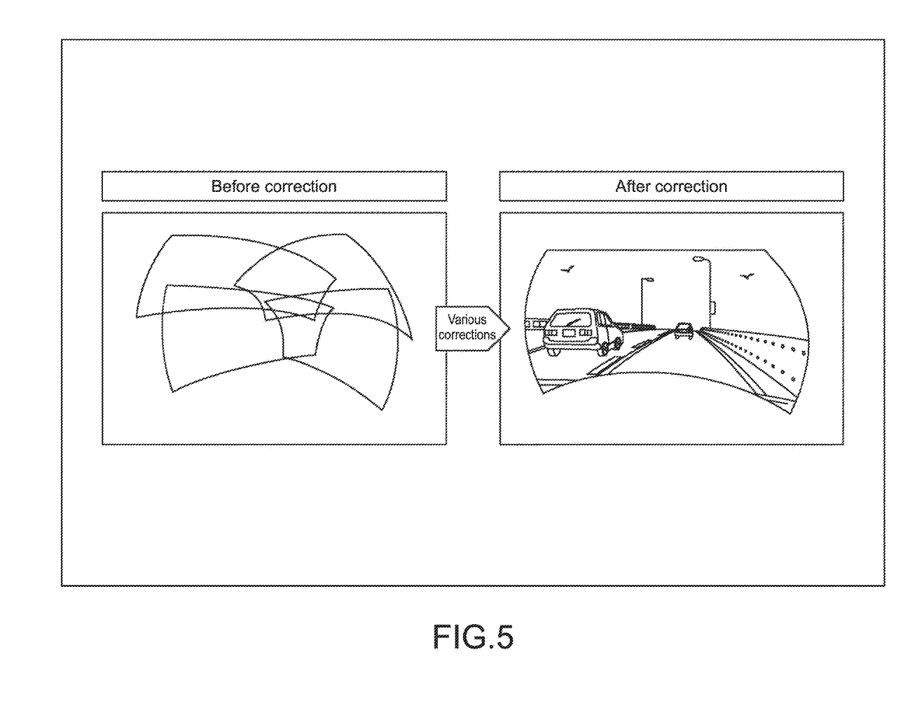

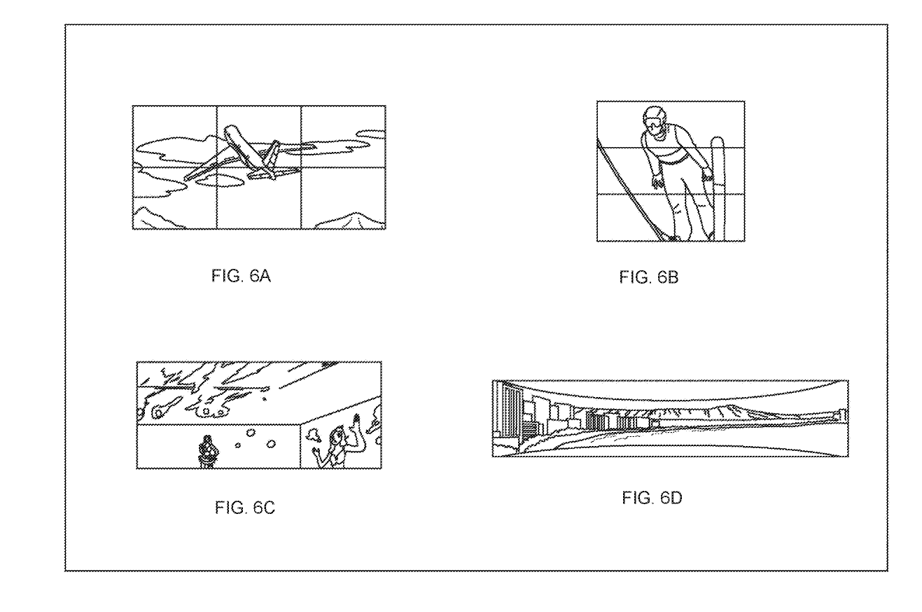

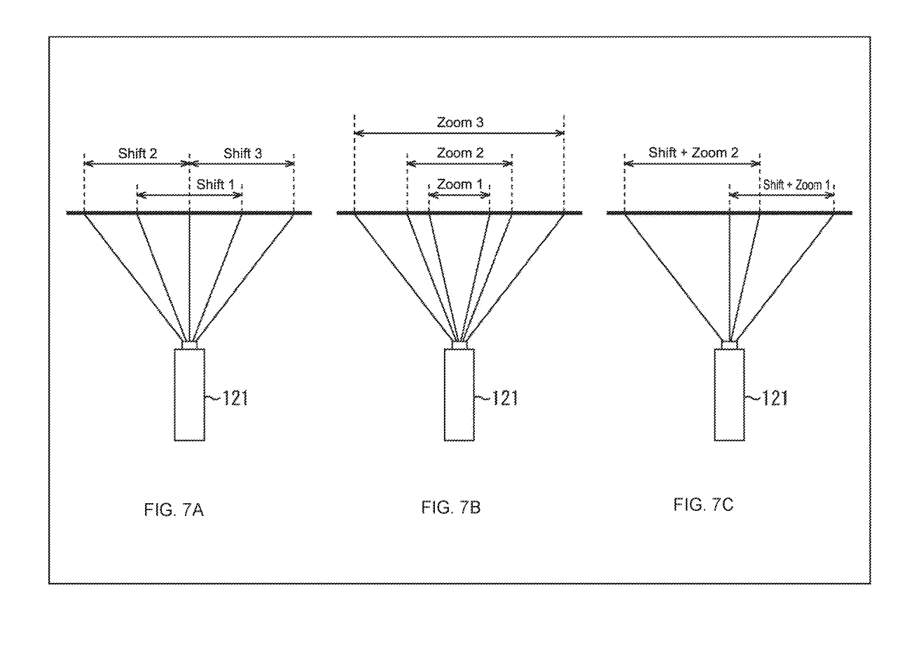

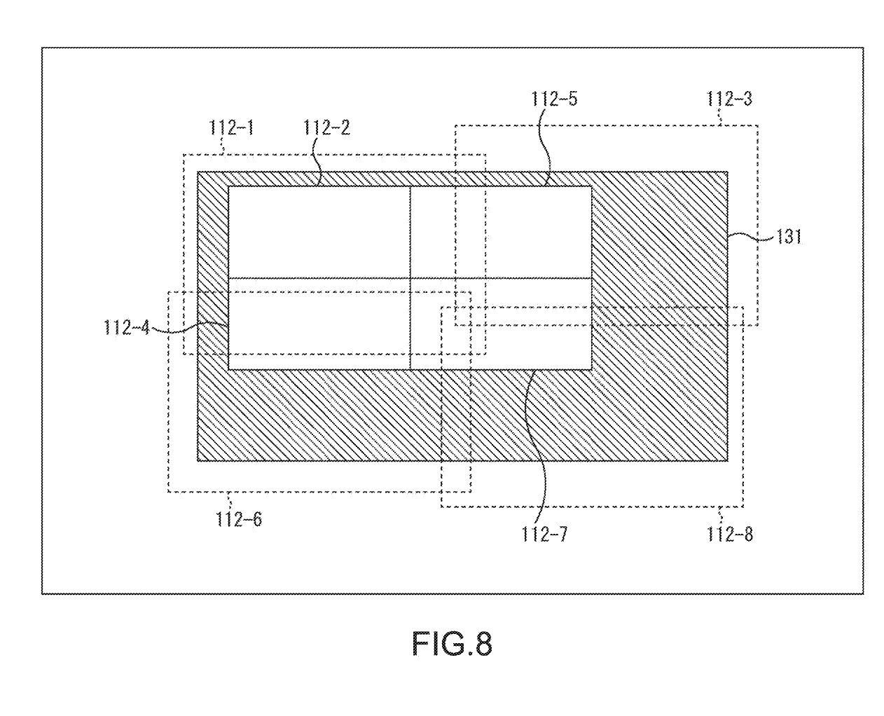

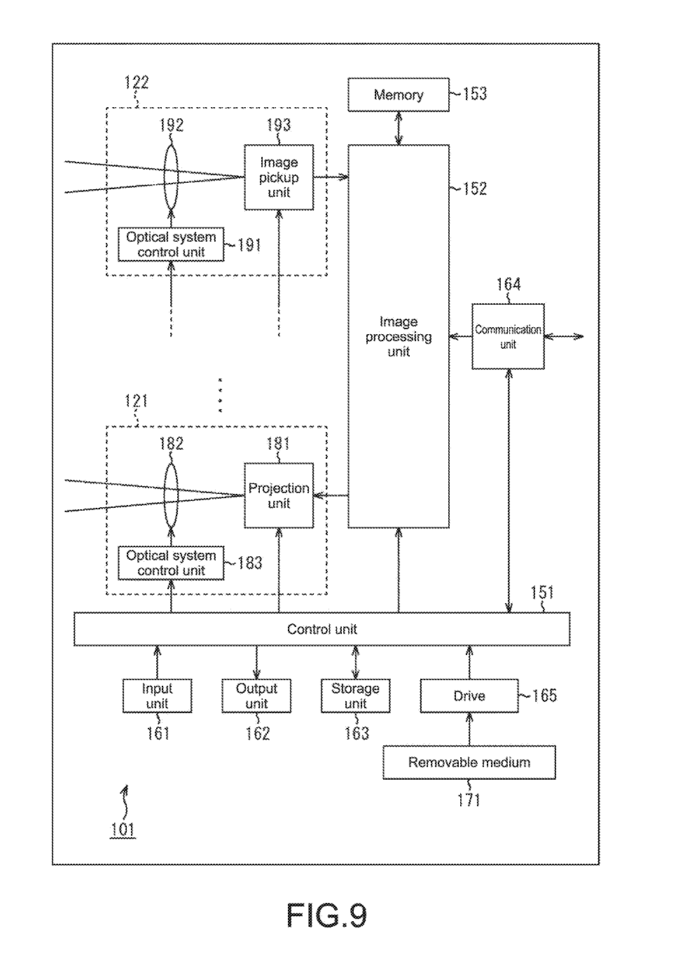

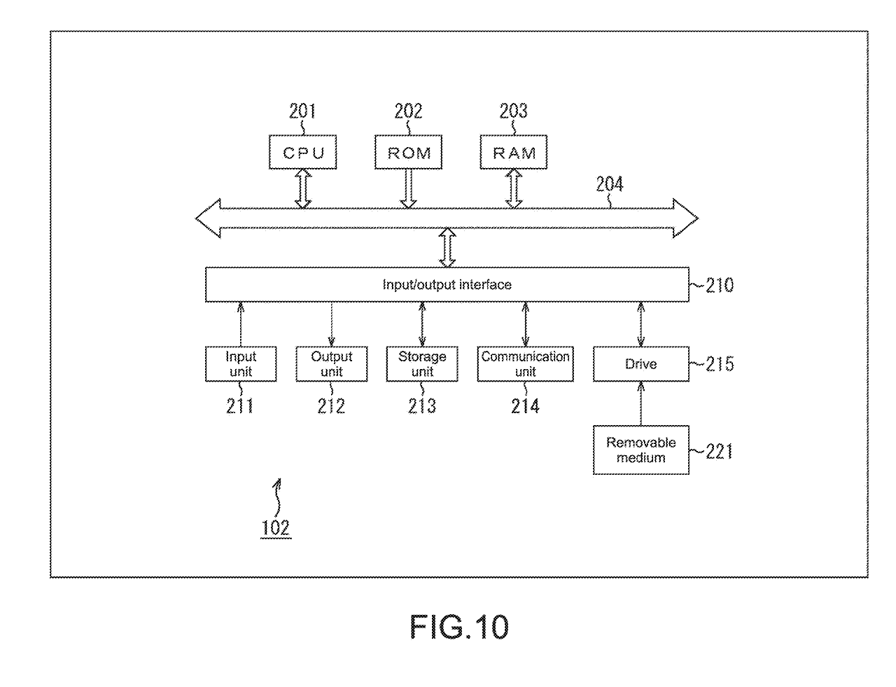

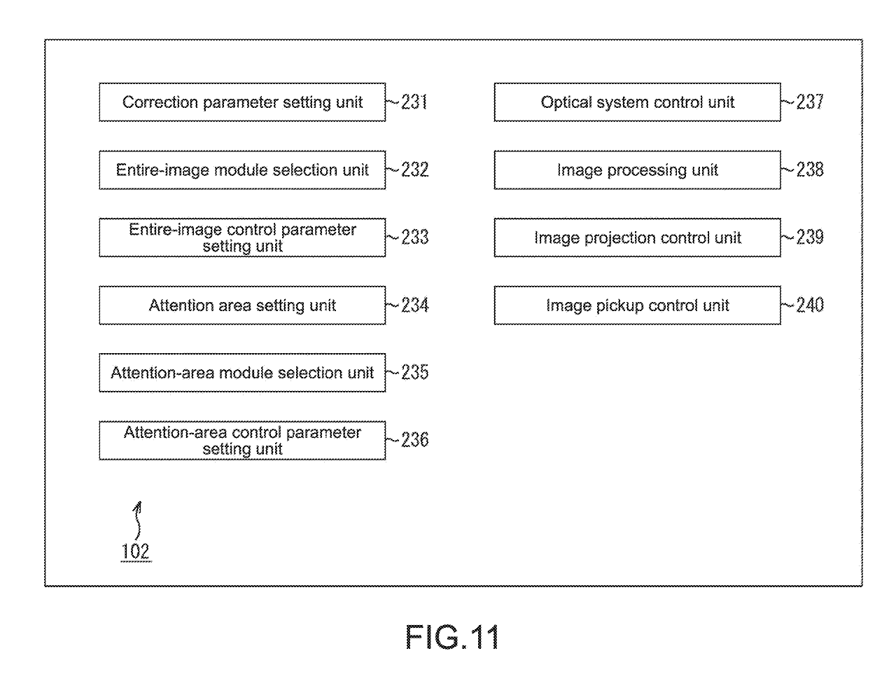

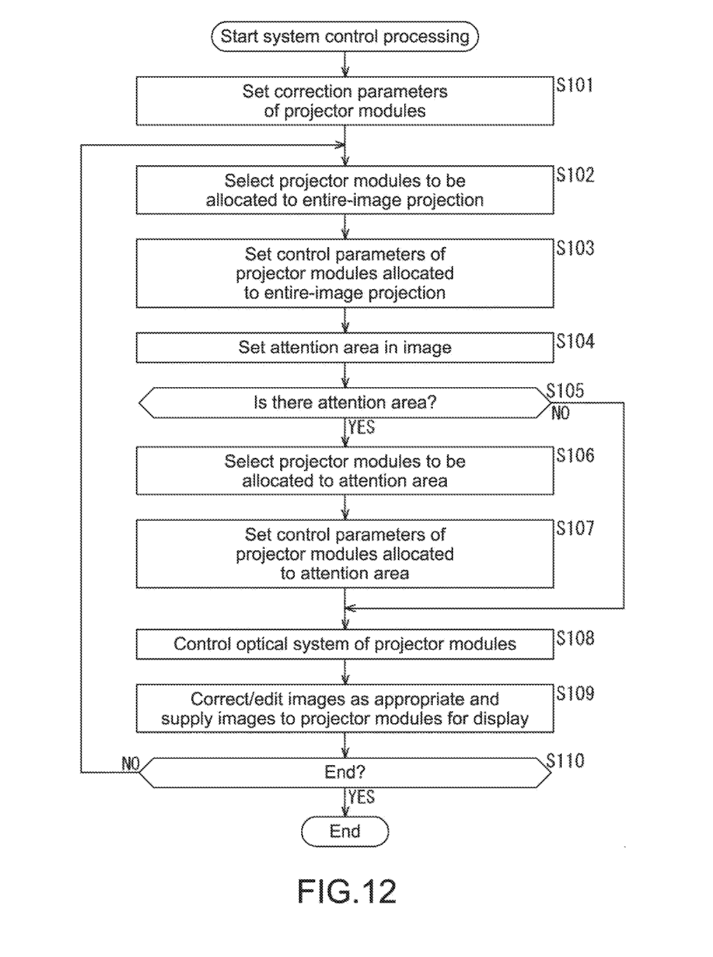

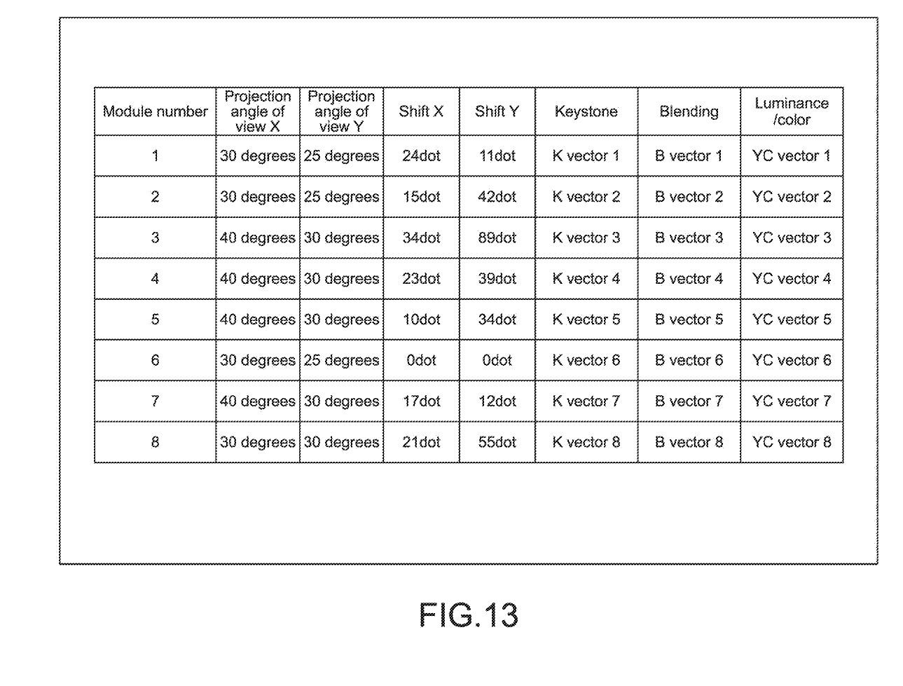

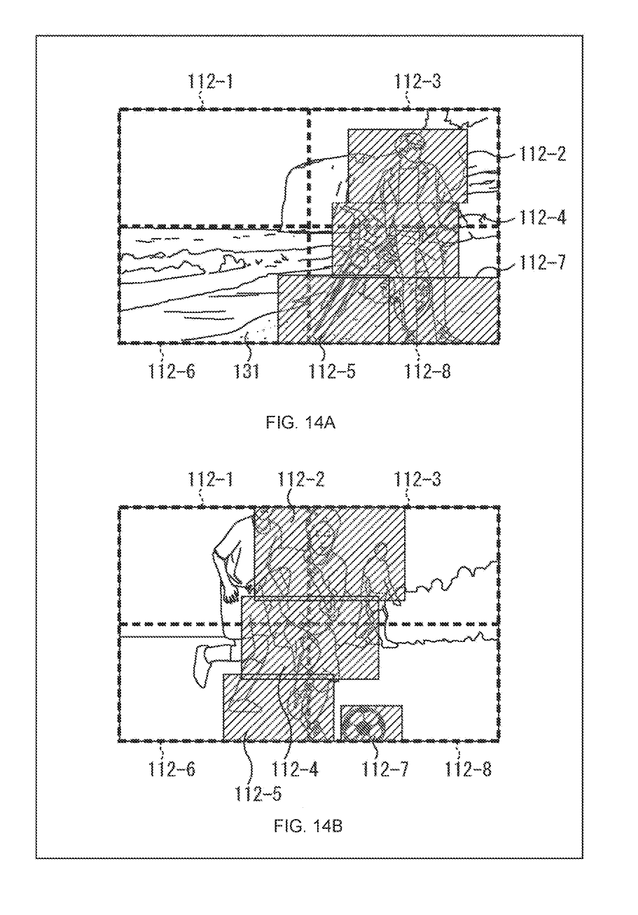

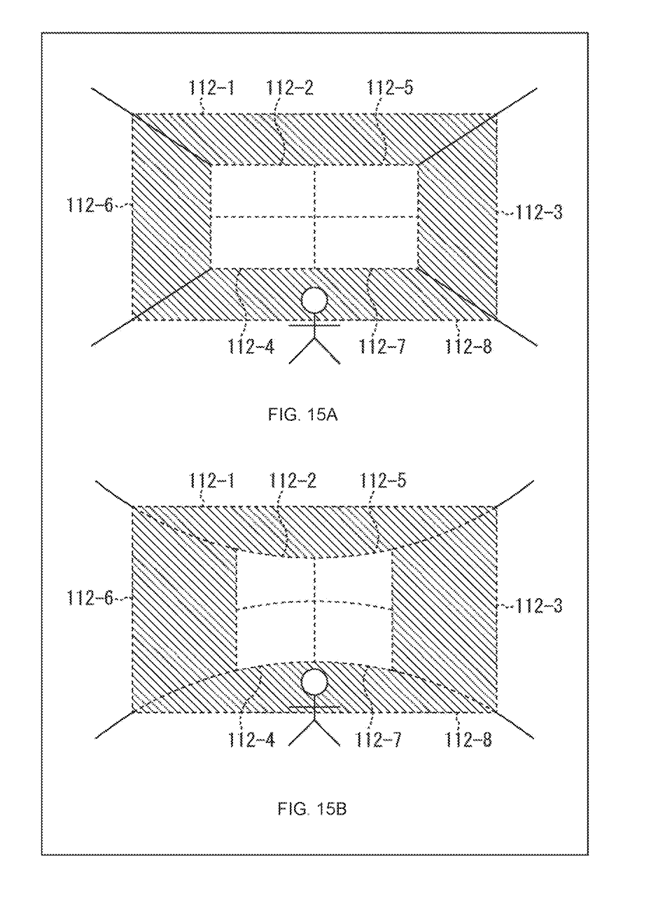

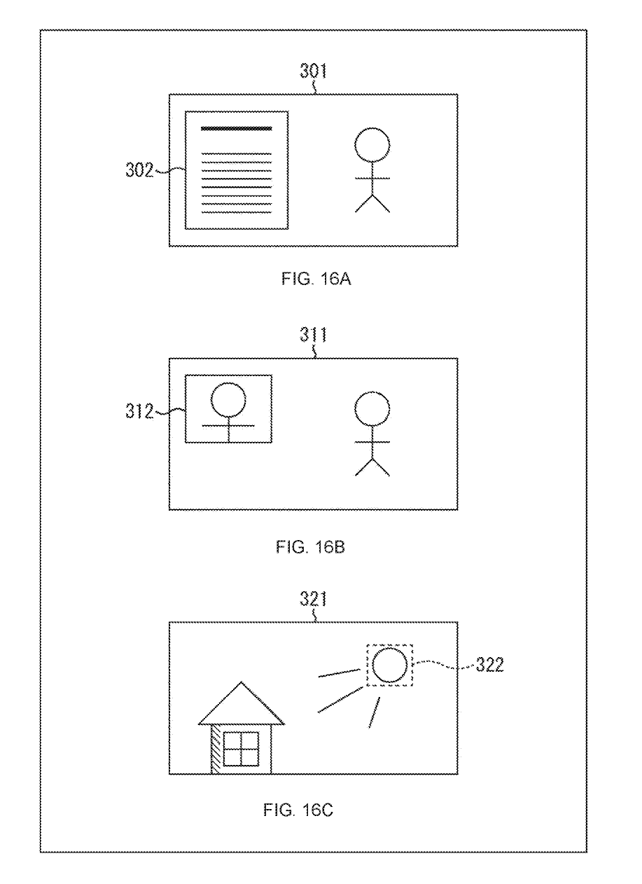

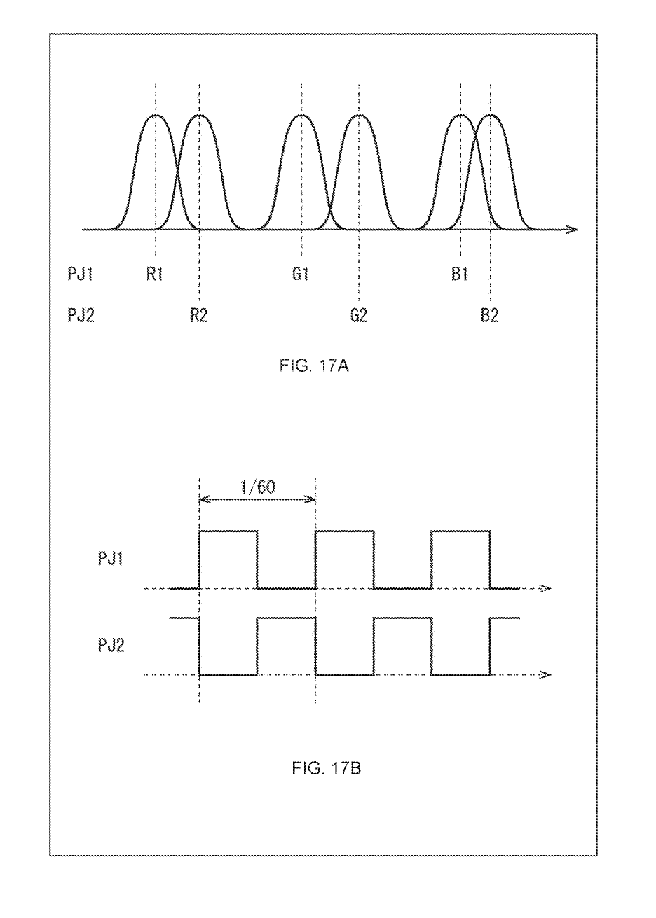

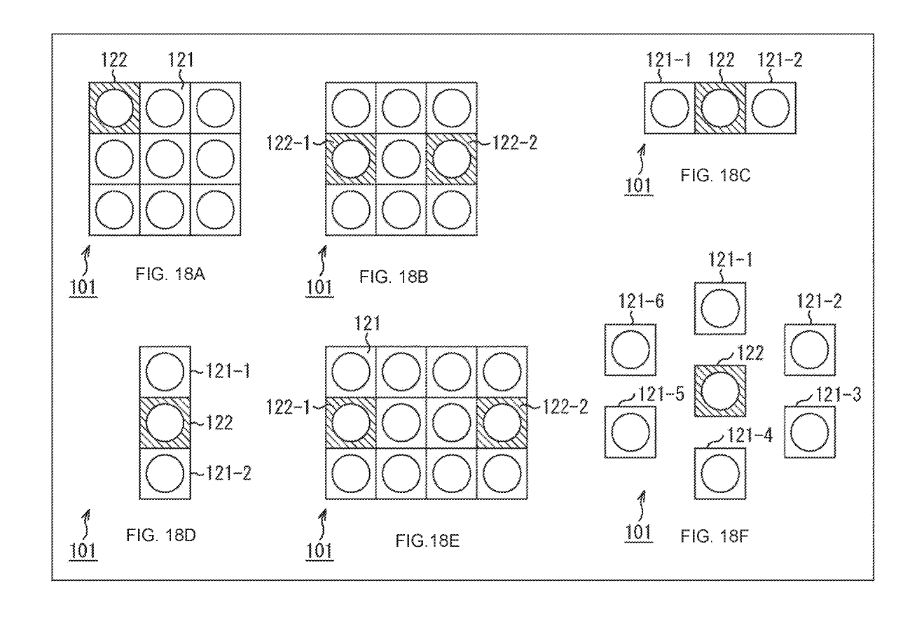

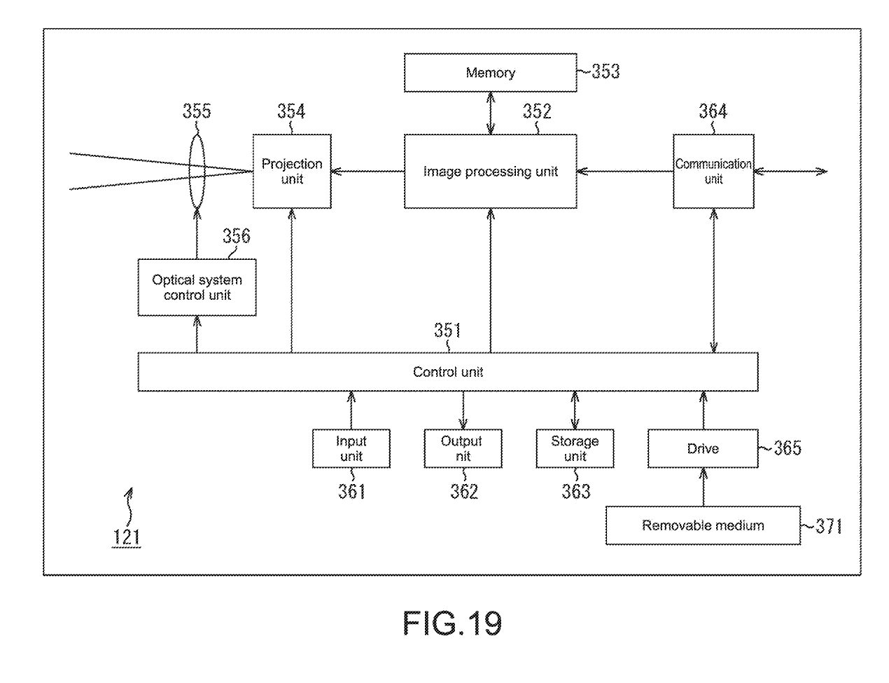

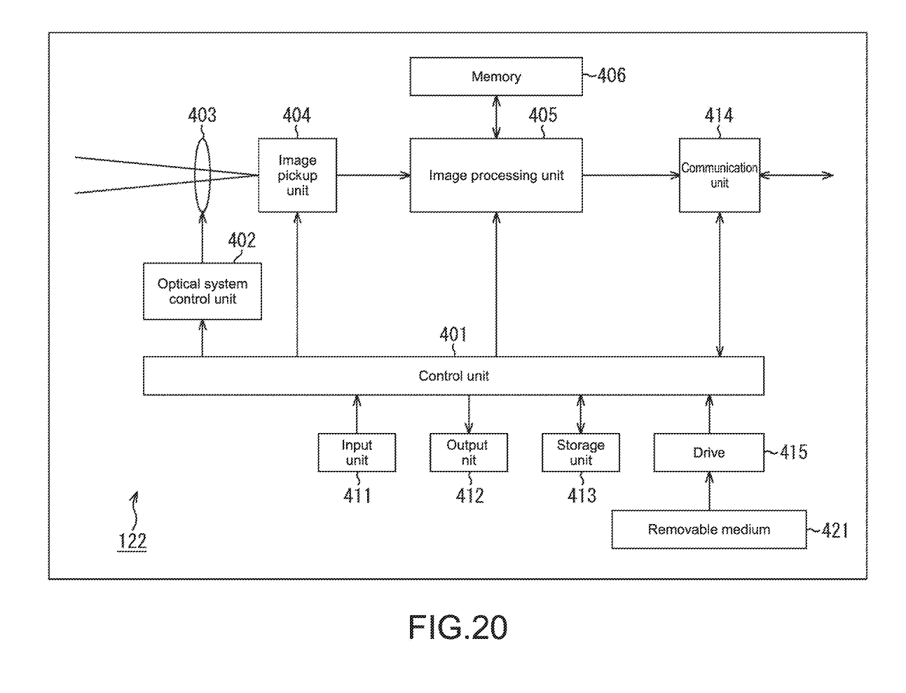

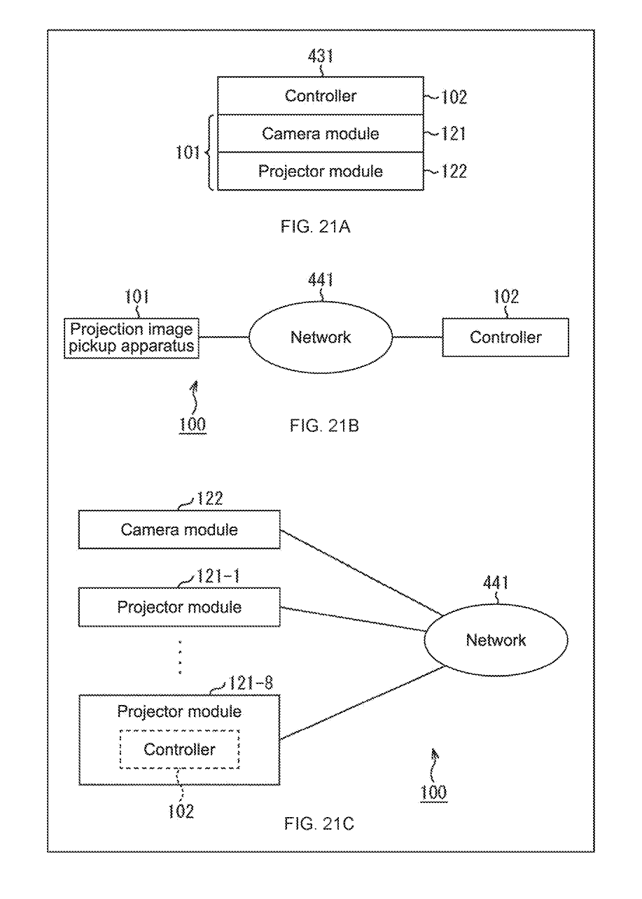

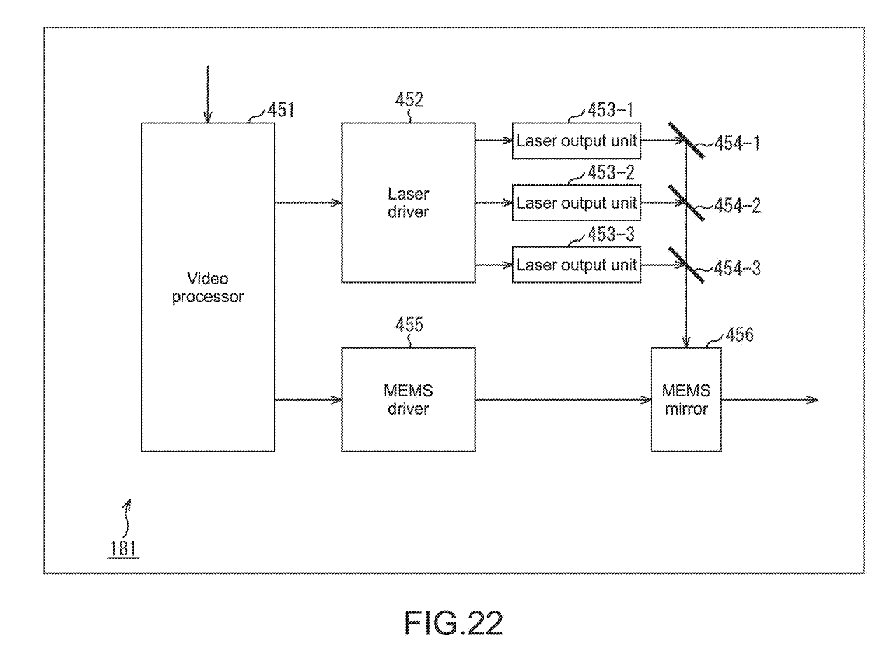

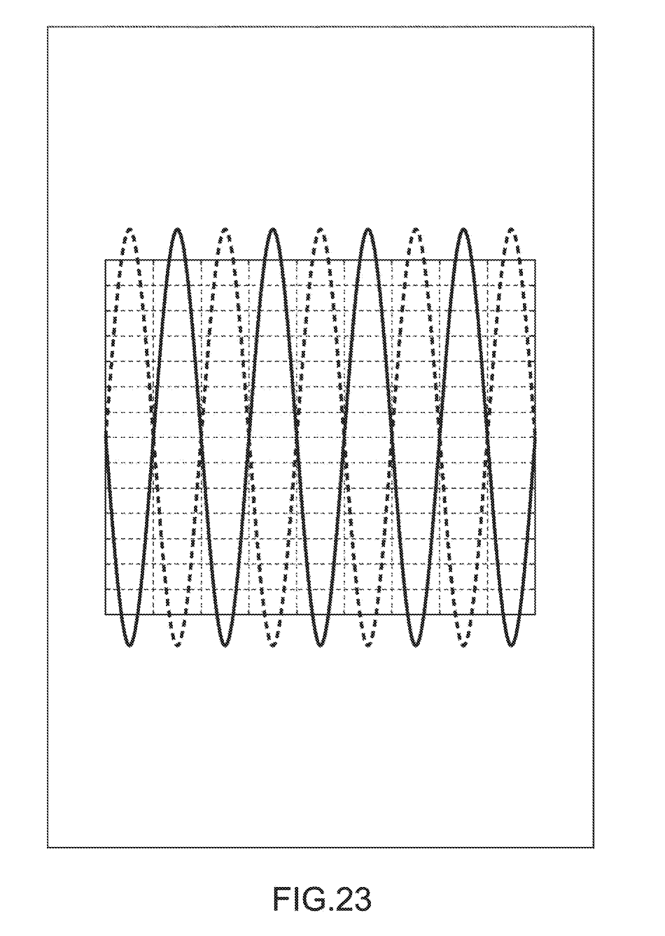

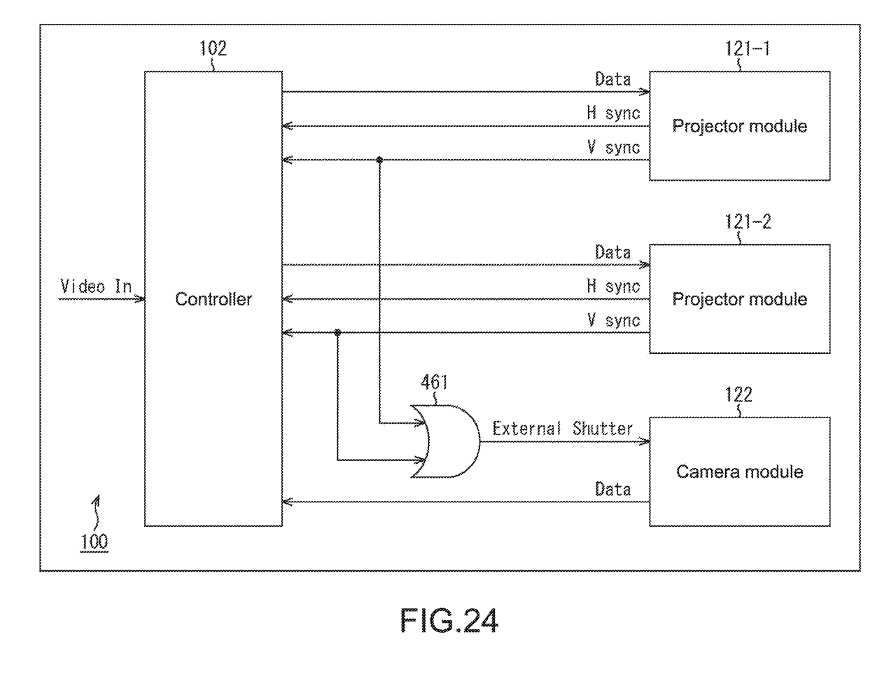

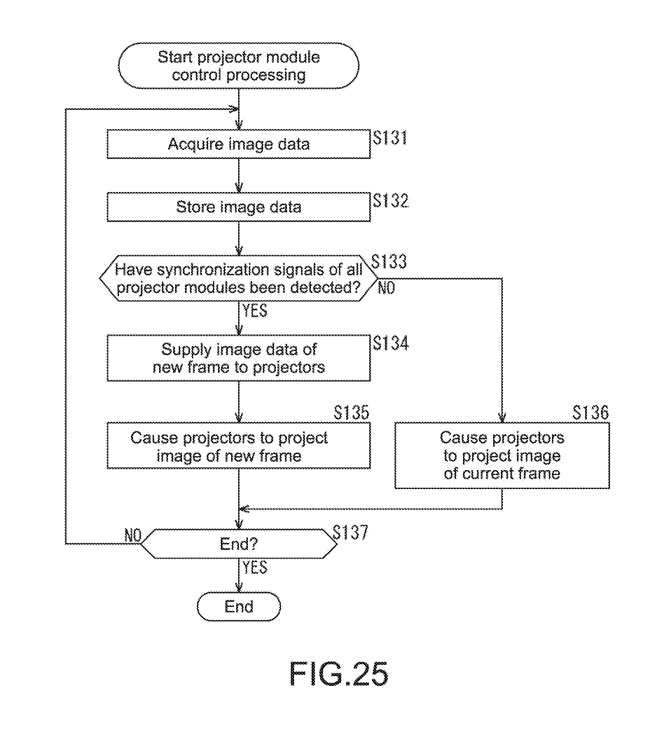

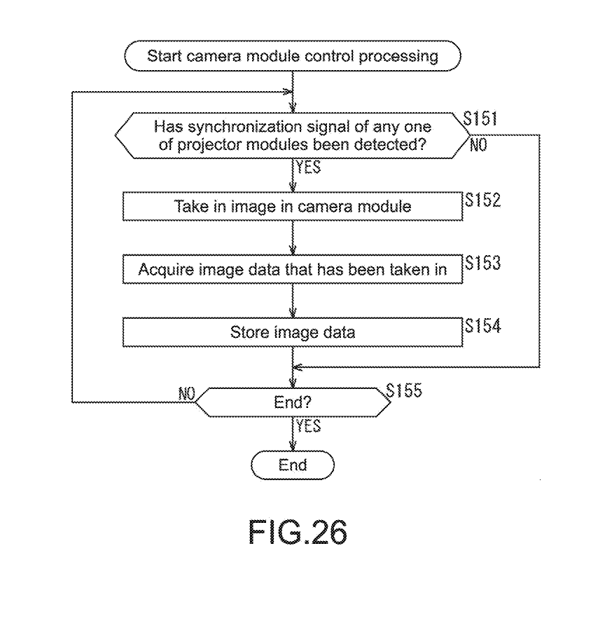

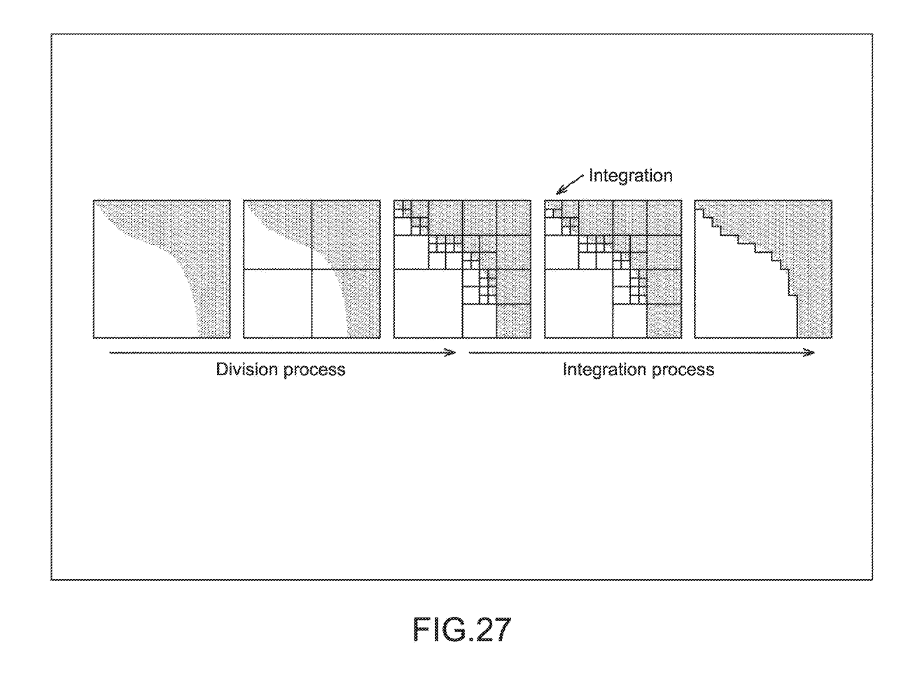

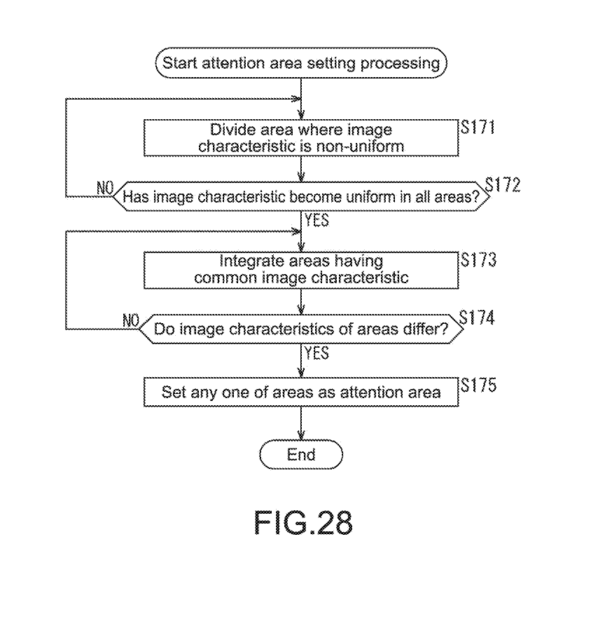

### BRIEF DESCRIPTION OF DRAWINGS

[FIG. 1] A diagram showing a main configuration example of a projection image pickup system.

[FIG. 2] Diagrams for explaining an outer appearance of the projection image pickup system.

[FIG. 3] Diagrams showing an example of an image projection state.

[FIG. 4] A diagram showing an image correction state.

[FIG. 5] A diagram showing the image correction state.

[FIG. 6] Diagrams for explaining usage examples.

[FIG. 7] Diagrams showing states of control of an attention area.

[FIG. 8] A diagram showing an example of an image projection state.

[FIG. 9] A block diagram showing a main configuration example of a projection image pickup apparatus.

[FIG. 10] A block diagram showing a main configuration example of a controller.

[FIG. 11] A functional block diagram showing an example of functions realized by the controller.

[FIG. 12] A flowchart for explaining an example of a flow of system control processing.

[FIG. 13] A diagram for explaining an example of control parameters.

[FIG. 14] Diagrams each showing the image projection state.

[FIG. 15] Diagrams each showing the image projection state.

[FIG. 16] Diagrams each showing the image projection state.

[FIG. 17] Diagrams each showing the image projection state.

[FIG. 18] Diagrams for explaining a module configuration example of the projection image pickup apparatus.

[FIG. 19] A block diagram showing a main configuration example of a projector module.

[FIG. 20] A block diagram showing a main configuration example of a camera module.

[FIG. 21] Diagrams respectively showing main configuration examples of the projection image pickup apparatus and projection image pickup system.

[FIG. 22] A block diagram showing a main configuration example of a projection unit.

[FIG. 23] A diagram showing an example of a laser light scan.

[FIG. 24] A diagram showing a main configuration example of the projection image pickup system.

[FIG. 25] A flowchart for explaining an example of a flow of projector module control processing.

[FIG. 26] A flowchart for explaining an example of a flow of camera module control processing.

[FIG. 27] A diagram for explaining an example of an area division state.

[FIG. 28] A flowchart for explaining an example of a flow of attention area setting processing.

### MODE FOR CARRYING OUT THE INVENTION

Hereinafter, a mode for embodying the present disclosure (hereinafter, referred to as embodiment) will be described. It should be noted that descriptions will be given in the following order.

### 1. First Embodiment (Projection Image Pickup System)

### 1. First Embodiment

<Projection Image Pickup System>

A main configuration example of a projection image pickup system to which a control apparatus, that is an embodiment of an information processing apparatus to which the present technology is applied, is applied is shown in FIG. 1. A projection image pickup system 100 shown in FIG. 1 is a system that projects images. As shown in FIG. 1, the projection image pickup system 100 includes a projection image pickup apparatus 101 and a controller 102. The projection image pickup apparatus 101 and the controller 102 are mutually connected by a cable 103.

The projection image pickup apparatus 101 is an apparatus that projects an image onto an image projection surface 111 and captures a projection image 112 projected onto the image projection surface 111. An image projected by the projection image pickup apparatus 101 may either be a moving image or a still image. Also, a captured image captured by the projection image pickup apparatus 101 may either be a moving image or a still image. Further, a speaker or the like may be provided in the projection image pickup apparatus 101 so as to enable the projection image pickup apparatus 101 to output audio. For example, the projection image pickup apparatus 101 may be configured to output audio corresponding to a projected image (e.g., BGM (Back Ground Music) etc.) or audio for confirming operations (e.g., beep sound, message, etc.).

The controller 102 controls the projection image pickup apparatus 101 via the cable 103. For example, the controller 102 supplies control signals to the projection image pickup apparatus 101 via the cable 103 to cause it to project or capture an image. The controller 102 also supplies data of an image to be projected by the projection image pickup apparatus 101 to the projection image pickup apparatus 101 via the cable 103 or acquires a captured image captured by the projection image pickup apparatus 101 from the projection image pickup apparatus 101 via the cable 103.

The cable 103 is a communication cable (transmission medium) of a predetermined standard such as a USB (Universal Serial Bus) and HDMI (registered trademark) (High-Definition Multimedia Interface), that is capable of transmitting control signals and content data including images, audio, and the like. The cable 103 may be configured by a single communication cable or may be configured by a plurality of communication cables.

The image projection surface 111 is a surface onto which images are projected by the projection image pickup apparatus 101. The image projection surface 111 may be a flat surface, a curved surface, or a surface including concavities and convexities in a part thereof or on the entire surface thereof, or may be configured by a plurality of surfaces. Moreover, the color of the image projection surface 111 is arbitrary and may be configured by a plurality of colors.

The image projection surface 111 may be formed on an arbitrary object. For example, the image projection surface 111 may be formed on a sheet-like object such as a so-called screen and a wall surface. Alternatively, the image projection surface 111 may be formed on a stereoscopic structure. For example, the image projection surface 111 may be formed on a wall surface of structures such as a building, a station building, and a castle, may be formed on a natural object such as a rock, an artificial construction such as a signboard and a bronze statue, and furniture such as a drawer, a chair, and a desk, or may be formed on living creatures such as human beings and animals. Moreover, the image projection surface 111 may be formed on a plurality of surfaces such as walls, floor, and ceiling of a room space, for example.

Further, the image projection surface 111 may be formed on a solid object or may be formed on liquid or a gaseous body. For example, the image projection surface 111 may be formed on a water surface of ponds, pools, and the like, a running-water surface of waterfalls, fountains, and the like, or a gaseous body of mists, gas, and the like. In addition, the image projection surface 111 may move, be deformed, or be changed in color. In addition, the image projection surface 111 may be formed on a plurality of objects such as a wall, furniture, and person in a room, a plurality of buildings, and a castle wall and fountain, for example.

<Structure of Projection Image Pickup Apparatus>

FIG. 2 are diagrams for explaining an example of a structure of the projection image pickup apparatus 101. As shown in FIG. 2A, the projection image pickup apparatus 101 includes projector modules 121-1 to 121-8 and a camera module 122.

The projector modules 121-1 to 121-8 have the same physical configuration. In other words, the projector modules 121-1 to 121-8 not only have a common casing shape but also a common internal physical configuration to be described later, and thus have similar functions. In descriptions below, the projector modules 121-1 to 121-8 will be referred to as projector modules 121 unless needing to distinguish them from one another.

The projector modules 121 are controlled by the controller 102 and project images supplied from the controller 102 onto the image projection surface 111. An example of an outer appearance of the projector module 121 is shown in FIGS. 2B and 2C. The projector modules 121 each emit light emitted inside the casing from a light-emitting portion 121A formed unidirectionally in the casing as shown in FIGS. 2B and 2C. As shown in FIG. 2A, the light-emitting portions 121A of the projector modules 121 are formed in substantially the same direction so that the projector modules 121 are capable of projecting images onto the same image projection surface 111.

The camera module 122 is controlled by the controller 102 to capture the projection images 112 projected onto the image projection surface 111 and acquire a captured image including the projection images 112. This captured image is supplied to the controller 102 to be used for the controller 102 to control the projector modules 121, for example. An example of an outer appearance of the camera module 122 is shown in FIGS. 2D and 2E. As shown in FIGS. 2D and 2E, the camera module 122 basically includes a casing having a shape similar to that of the projector modules 121. Also regarding the internal physical configuration of the camera module 122, parts that can be made common with the projector modules 121, such as an optical system, are made common with the projector modules 121.

Further, the camera module 122 photoelectrically converts light that has entered a light incident portion 122A formed unidirectionally in the casing as shown in FIGS. 2D and 2E inside the casing to obtain a captured image. As shown in FIG. 2A, the light incident portion 122A of the camera module 122 is formed in substantially the same direction as the light-emitting portion 121A of the projector modules 121 so as to be capable of capturing a projection image projected onto the image projection surface 111 by the projector modules 121.

As shown in FIG. 2A, in the projection image pickup apparatus 101, the projector modules 121-1 to 121-8 and the camera module 122 are arranged 3 each in the longitudinal and lateral directions. The modules (projector modules 121-1 to 121-8 and camera module 122) are fixed to one another. Therefore, relative positions (relative positions of light-emitting portions 121A) are fixed. Although details will be described later, for cooperating with one another to project images under control of the controller 102, the projector modules 121 mutually correct positions and distortions of projection images. A relative positional relationship among the projector modules 121 is used for control of such a correction. Since the relative positions are fixed as described above, control of the correction of positions and distortions of projection images becomes easier.

Further, although details will be described later, a captured image captured by the camera module 122 is also used for the control of the correction of positions and distortions of projection images. For example, by also applying corrections corresponding to the shape, angle, and the like of the image projection surface 111, the positions and distortions of projection images can be corrected more accurately. Therefore, the controller 102 can apply control of the corrections based on a projection image (i.e., captured image) as an actual projection result. For using the captured image for the control, the relative positional relationship among the camera module 122 and the projector modules 121 becomes necessary. Since the relative positions are fixed as described above, control of the correction of positions and distortions of projection images using a captured image becomes easier.

It should be noted that in the case of the example shown in FIG. 2A, the camera module 122 is arranged at the center of the module group arranged 3 each in the longitudinal and lateral directions, and 8 projector modules 121 are arranged so as to surround the camera module 122. By arranging the modules as described above, relative distances between the respective projector modules 121 and the camera module 122 become more uniform and shorter, with the result that the control of the correction of positions and distortions of projection images using a captured image becomes easier. Moreover, it becomes possible to uniformize the arrangement of the projector modules 121 in the longitude, lateral, and oblique directions and the like and make the relative positions of the modules at both ends in the respective directions shorter. Accordingly, distortions of the projection images 112 projected by the projector modules 121 can be reduced for images having a greater diversity of aspect ratios.

Further, although the physical configurations of the modules may be differentiated, by making the physical configurations of the modules common as much as possible as described above, an increase of production costs can be suppressed. Moreover, production can be made easier.

<Cooperative Projection>

For example, it is assumed that content data including an image of a progressive scan system (4K@60P), that has a resolution of 4K (e.g., 4096*2160) and a frame rate of 60 fps, is supplied to the projector modules 121. Each of the projector modules 121 supplied with the content data cuts out a partial image of that image (4Kp60P) allocated to the module itself (e.g., image of progressive scan system, that has full HD resolution and frame rate of 60 fps (1080@60P)) and projects it onto the image projection surface 111.

For example, the projector module 121-1, the projector module 121-3, the projector module 121-6, and the projector module 121-8 project images in the arrangement as shown in FIG. 3A. In the example shown in FIG. 3A, projection images of the projector modules 121 are projected 2 in the longitudinal direction and 2 in the lateral direction (2*2) on the image projection surface 111. More specifically, a projection image 112-1 of the projector module 121-1 is projected at an upper left-hand side of the image projection surface 111, a projection image 112-3 of the projector module 121-3 is projected at an upper right-hand side of the image projection surface 111, a projection image 112-6 of the projector module 121-6 is projected at a lower left-hand side of the image projection surface 111, and a projection image 112-8 of the projector module 121-8 is projected at a lower right-hand side of the image projection surface 111.

As shown in FIG. 3A, these projection images 112 (projection image 112-1, projection image 112-3, projection image 112-6, and projection image 112-8) partially overlap one another and form one area. These projection images 112 include the partial images (1080@60P) described above and form a projection image 131 of the image (4K@60P) on the image projection surface 111 in the projected state as shown in FIG. 3A. More specifically, the projection image 112-1 includes an upper-left partial image of the projection image 131 (4K@60P), the projection image 112-3 includes an upper-right partial image of the projection image 131 (4K@60P), the projection image 112-6 includes a lower-left partial image of the projection image 131 (4K@60P), and the projection image 112-8 includes a lower-right partial image of the projection image 131 (4K@60P). Since the projection images 112 partially overlap one another as described above, the partial images included in the respective projection images 112 may be images having a higher resolution (i.e., wider range) than full HD images.

By the projector module 121-1, the projector module 121-3, the projector module 121-6, and the projector module 121-8 cooperating with one another as described above, the projection image pickup system 100 can project a 4K-resolution image (4K@60P) without lowering the resolution (without lowering image quality).

It should be noted that for realizing such a projection image 131, positioning, geometric corrections, and the like of the projection images 112 are necessary. The camera module 122 includes an image pickup function and is capable of sensing the projection images 112 projected by the projector modules 121 using the image pickup function as shown in FIG. 3B. In the example shown in FIG. 3, the camera module 122 is capturing the projection image 112-8 (partial image 131-8) of the projector module 121-8. By the controller 102 carrying out various corrections on the basis of this sensor data, the partial images can be synthesized in a more natural form so as to form one projection image 131.

As contents of image corrections, there are a projector individual difference correction, an overlap correction, and a screen shape correction as shown in FIG. 3B, for example. The projector individual difference correction is a correction with respect to luminance, gamma, brightness, contrast, white balance, tone, and the like, for example. The overlap correction is a correction with respect to an overlap area as an area where the projection images 112 overlap each other and includes, for example, a level correction and a distortion correction. The screen shape correction is a correction for coping with the shape and posture of the image projection surface 102 and includes, for example, a projection conversion (flat, spherical, cylindrical (columnar), polynomial curve). Of course, other corrections may also be carried out.

For example, a projection image is distorted unless being subjected to the correction in a case where the image projection surface 102 faces an oblique direction with respect to the projection image pickup apparatus 101 as shown in FIG. 4, the distortion can be reduced by the projection conversion and the like. Further, for example, also when projecting a plurality of images on a curved surface as shown in FIG. 5, the images can be projected like a single image by the projection conversion and the like.

<Usage Example of Projection Image Pickup System>

By using such a projection image pickup system 100, various projections become possible. For example, by arranging a plurality of projection images as shown in FIG. 6A, a resolution of a projection image can be raised. Moreover, as shown in the example of FIG. 6B, depending on the arrangement of the projection images (partial images) projected by the projector modules 121, an aspect ratio of a projection image (entire image) can be set freely without depending on the specification of the projector modules 121.

Further, as shown in the example of FIG. 6C, images can be projected onto a plurality of walls and a ceiling (i.e., screens facing plurality of directions (that is, 3D structure)) without distortions. Furthermore, as shown in the example of FIG. 6D, it is also possible to project an image onto a wide curved screen so as to surround viewers without distortions.

By raising a degree of freedom of such a projection surface, it becomes possible to improve a lively feeling and visibility, for example, due to an enhancement of expressiveness of projection images, and improve entertainment and artistic quality of the expressions.

<Local Control of Characteristics of Projection Image>

In an image projection system of the past, a controller 102 has corrected individual differences and relative positions of projectors to control image projections of the projectors so as to obtain one large projection image 131 having uniform characteristics.

However, there is a rising demand for expressiveness of projection images projected by the projectors. For example, projection images in which image characteristics such as luminance and resolution are not uniform are being demanded, and there has been a fear that such projection images cannot be realized with the system of the past.

In this regard, a first projection unit is controlled so that a first image is projected onto an image projection surface, and a second projection unit is controlled so that a second image is projected in an attention area as a predetermined partial area of the first image projected onto the image projection surface by the first projection unit.

For example, an information processing apparatus that controls the first projection unit and the second projection unit includes a control unit that controls the first projection unit to project the first image onto the image projection surface and controls the second projection unit to project the second image in the attention area as a predetermined partial area of the first image projected onto the image projection surface by the first projection unit.

More specifically, in the case of the projection image pickup system 100 shown in FIG. 1, the controller 102 controls a part of the projector modules 121 (first projection unit) of the projection image pickup apparatus 101 to project the first images onto the image projection surface 111 so as to obtain a large projection image 131 and controls the other projector modules 121 (second projection unit) of the projection image pickup apparatus 101 to project the second images in the attention area as a predetermined partial area of the large projection image 131 described above projected onto the image projection surface 111.

It should be noted that image characteristics (parameters) to be locally varied in a projection image are arbitrary. For example, the image characteristics (parameters) may be luminance, colors, resolution, frame rate, and the like. A plurality of characteristics (parameters) may be varied locally. Moreover, a picture of the second image may be the same as or different from the partial images projected in the attention area of the first image. In addition, the position, shape, and size of the attention area (i.e., second image) are arbitrary (only needs to be smaller than projection image of first image). The attention area may be independent for each characteristic. Further, the number of projection units used for projecting the first image is arbitrary and may be single or plural. The number of projection units used for projecting the second image is also arbitrary and may be single or plural. Furthermore, the number of attention areas is also arbitrary and may be single or plural. In a case where a plurality of attention areas are provided, characteristics and pictures of the second images projected in the respective attention areas may be the same or may differ. In addition, in the case where a plurality of attention areas are provided, the number of projection units used for projecting onto the respective attention areas is arbitrary and may be single or plural, and the projection units may mutually be the same or may differ from one another.

<Control of Direction and Angle of View of Projection>

Further, it is also possible to cause, by setting the attention area at an arbitrary portion of the first image projected onto the image projection surface and controlling the projection direction and angle of view of the other projection units as described above, the second image to be projected onto the set attention area. For example, in the case of the projection image pickup system 100, the controller 102 sets an attention area of an arbitrary size and shape at arbitrary positions of a large projection image 131 on the image projection surface 111 and controls the projection direction and angle of view of the other projector modules 121 described above so as to project the second images onto the attention areas.

In the case of the example shown in FIG. 7A, the image projection directions (shift amounts and shift directions) of the projector modules 121 are controlled as in shift 1, shift 2, and shift 3. Moreover, in the case of the example shown in FIG. 7B, the image projection angle of view (zoom amount, size of projection range) of the projector modules 121 is controlled as in zoom 1, zoom 2, and zoom 3. In the example shown in FIG. 7C, the example of FIG. 7A and the example of FIG. 7B are combined, and both the image projection direction and projection angle of view of the projector modules 121 are controlled. By controlling each of the projector modules 121 in this way, the controller 102 can project the second images onto arbitrary portions of the projection image 131 (projected first images) (arbitrary portion can be set as attention area).

<Projection Image Example>

The projection image pickup system 100 is capable of projecting images as shown in FIG. 8, for example. In the case of the example shown in FIG. 8, the projection image 112-1 of the projector module 121-1, the projection image 112-3 of the projector module 121-3, the projection image 112-6 of the projector module 121-6, and the projection image 112-8 of the projector module 121-8 form the projection image 131 (projection image of first images) as described with reference to FIG. 3A. Further, a projection image 112-2 of the projector module 121-2, a projection image 112-4 of the projector module 121-4, a projection image 112-5 of the projector module 121-5, and a projection image 112-7 of the projector module 121-7 are formed inside the projection image 131. In other words, the respective parts of the projection image 112-2, projection image 112-4, projection image 112-5, and projection image 112-7 of the projection image 131 are set as attention areas, and the second images are projected in the attention areas.

For example, by projecting a second image having the same picture as the first image in the respective attention areas, luminance of the attention areas can be increased as compared to an area outside the attention areas. At this time, luminance of the second images can be varied so as become higher or lower than the luminance of the first images. Moreover, by projecting translucent gray images in the attention areas as the second images, luminance of the attention areas can be made pseudo lower than that outside the attention areas.

Further, the projection image 112-2, the projection image 112-4, the projection image 112-5, and the projection image 112-7 are projection images obtained by narrowing the projection angle of view of the projector modules 121 by angle of view control (zoom control). Therefore, these projection images can be made to have a higher resolution than the projection image 131. For example, by projecting the second images having a higher resolution than the first images in the attention areas, the resolution of the attention areas can be made higher than that outside the attention areas.

In this way, projection image characteristics can be varied locally. For example, image characteristics (e.g., luminance, resolution, etc.) can be varied between predetermined attention areas and areas outside the attention areas in a projection image. Accordingly, since expressiveness of the projection image is enhanced (projection of images exceeding expression ability of projector modules 121 becomes possible), it becomes possible to improve a lively feeling and visibility and also improve entertainment and artistic quality of the expressions, for example.

Further, by the controller 102 setting arbitrary portions of the projection image as the attention areas and controlling the projection direction and angle of view of the projector modules so that the second images are projected in the attention areas, the image characteristics can be varied locally at the arbitrary portions of the projection image.

<Configuration of Projection Image Pickup Apparatus>

FIG. 9 is a block diagram showing a main configuration example of the projection image pickup apparatus 101. As shown in FIG. 9, the projection image pickup apparatus 101 includes a control unit 151, an image processing unit 152, a memory 153, the projector modules 121, the camera module 122, an input unit 161, an output unit 162, a storage unit 163, a communication unit 164, and a drive 165.

The projector modules 121 each include a projection unit 181, an optical system 182, and an optical system control unit 183. The camera module 122 includes an optical system control unit 191, an optical system 192, and an image pickup unit 193.

The projection unit 181 of the projector module 121 carries out processing related to projection of images. For example, the projection unit 181 emits projection light under control of the control unit 151 and projects an image of image data supplied from the image processing unit 152 outside the projection image pickup apparatus 101 (e.g., image projection surface 111 etc.). In other words, the projection unit 181 realizes a projection function. A light source of the projection unit 181 is arbitrary and may be an LED (Light Emitting Diode), xenon, or the like. Further, laser light may be emitted as the projection light emitted by the projection unit 181. The projection light emitted by the projection unit 181 exits the projection image pickup apparatus 101 via the optical system 182.

The optical system 182 includes a plurality of lenses, a diaphragm, and the like, for example, and imparts an optical influence to the projection light emitted from the projection unit 181. For example, the optical system 182 controls a focal distance of projection light, exposure, projection direction, projection angle of view, and the like.

The optical system control unit 183 includes an actuator, an electromagnetic coil, and the like and controls the optical system 182 under control of the control unit 151 to control the focal distance of projection light, exposure, projection direction, projection angle of view, and the like.

The optical system control unit 191 of the camera module 122 includes an actuator, an electromagnetic coil, and the like and controls the optical system 192 under control of the control unit 151 to control a focal distance of incident light, exposure, image pickup direction and angle of view, and the like.

The optical system 192 includes a plurality of lenses, a diaphragm, and the like, for example, and imparts an optical influence to the incident light that enters the image pickup unit 193. For example, the optical system 192 controls a focal distance of incident light, exposure, image pickup direction and angle of view, and the like.

The image pickup unit 193 includes an image sensor. By photoelectrically converting incident light that enters via the optical system 192 using that image sensor, a subject outside the apparatus is captured, and a captured image is generated. The image pickup unit 193 supplies data of the obtained captured image to the image processing unit 152. In other words, the image pickup unit 193 realizes an image pickup function (sensor function). For example, the image pickup unit 193 captures the projection image 112 projected onto the image projection surface 111 by the projection unit 181. It should be noted that the image sensor provided in the image pickup unit 193 is arbitrary and may be a CMOS image sensor that uses CMOS (Complementary Metal Oxide Semiconductor) or a CCD image sensor that uses CCD (Charge Coupled Device), for example.

The control unit 151 includes therein a CPU (Central Processing Unit), a ROM (Read Only Memory), a RAM (Random Access Memory), and the like and executes programs and processes data to carry out processing related to control of the respective processing units of the projection image pickup apparatus 101. In other words, the respective processing units of the projection image pickup apparatus 101 carry out processing related to the projection, image pickup, and the like under control of the control unit 151.

For example, the control unit 151 acquires control information related to a projection, that is supplied from the controller 102, via the communication unit 164. For example, the control unit 151 controls the image processing unit 152 to carry out predetermined image processing on an image to be projected on the basis of the control information. Further, for example, the control unit 151 controls the projection unit 181 of the projector module 121 to project an image on the basis of the control information. Furthermore, for example, the control unit 151 controls the optical system control unit 183 of the projector module 121 to control the focal distance of projection light, exposure, projection direction, projection angle of view, and the like on the basis of the control information.

Further, for example, the control unit 151 acquires control information related to image pickup, that is supplied from the controller 102, via the communication unit 164. For example, the control unit 151 controls the optical system control unit 191 of the camera module 122 to control the focal distance of incident light, exposure, image pickup direction and angle of view, and the like on the basis of the control information. Moreover, for example, the control unit 151 controls the image pickup unit 193 of the camera module 122 to capture an image on the basis of the control information. Further, for example, the control unit 151 controls the image processing unit 152 to carry out predetermined image processing on a captured image on the basis of the control information.

The image processing unit 152 carries out image processing on an image to be projected and a captured image obtained by image pickup. For example, the image processing unit 152 acquires image data supplied from the controller 102 via the communication unit 164 and stores it in the memory 153. The image processing unit 152 also acquires data of a captured image (captured image data) supplied from the image pickup unit 193, for example, and stores it in the memory 153. The image processing unit 152 reads out the image data or captured image data stored in the memory 153 and carries out image processing, for example. Contents of the image processing are arbitrary and include, for example, processing such as cutting and synthesizing, a parameter adjustment, and the like. The image processing unit 152 stores the image data or captured image data that has been subjected to the image processing in the memory 153.

Further, for example, the image processing unit 152 reads out the image data stored in the memory 153, supplies it to the projection unit 181 of a desired projector module 121, and causes it to project that image. Further, for example, the image processing unit 152 reads out the captured image data stored in the memory 153 and supplies it to the controller 102 via the communication unit 164.

The memory 153 stores the image data and captured image data processed by the image processing unit 152 and supplies the stored image data or captured image data to the image processing unit 152 in response to a request from the image processing unit 152 and the like.

The input unit 161 is constituted of an input device that receives external information such as a user input. For example, the input unit 161 includes operation buttons, a touch panel, a camera, a microphone, an input terminal, and the like. The input unit 161 may also include various sensors such as an acceleration sensor, an optical sensor, and a temperature sensor. The output unit 162 is constituted of an output device that outputs information such as images and audio. For example, the output unit 162 includes a display, a speaker, an output terminal, and the like.

The storage unit 163 is constituted of a storage medium that stores information such as programs and data. For example, the storage unit 163 includes a hard disk, a RAM disk, a nonvolatile memory, and the like. The communication unit 164 is constituted of a communication device that performs communication for exchanging information such as programs and data with external apparatuses via a predetermined communication medium. The communication unit 164 is constituted of, for example, a network interface. For example, the cable 103 is connected to the communication unit 164. The communication unit 164 communicates (exchanges programs, data, etc.) with the controller 102 via the cable 103.

The drive 165 reads out information (programs, data, etc.) stored in a removable medium 171 loaded therein, examples of the removable medium 171 including a magnetic disk, an optical disc, a magneto-optical disc, and a semiconductor memory. The drive 165 supplies information read out from the removable medium 171 to the control unit 151. In a case where a writable removable medium 171 is loaded into the drive 165, the drive 165 is also capable of storing information (programs, data, etc.) supplied via the control unit 151 in the removable medium 171.

<Configuration of Controller>

FIG. 10 is a block diagram showing a main configuration example of the controller 102. As shown in FIG. 10, in the controller 102, a CPU 201, a ROM 202, and a RAM 203 are connected to one another via a bus 204.

An input/output interface 210 is also connected to the bus 204. An input unit 211, an output unit 212, a storage unit 213, a communication unit 214, and a drive 215 are connected to the input/output interface 210.

The input unit 211 is constituted of an input device that receives external information such as a user input. For example, the input unit 211 includes a keyboard, a mouse, operation buttons, a touch panel, a camera, a microphone, an input terminal, and the like. The input unit 211 may also include various sensors such as an acceleration sensor, an optical sensor, and a temperature sensor and an input apparatus such as a barcode reader. The output unit 212 is constituted of an output device that outputs information such as images and audio. For example, the output unit 212 includes a display, a speaker, an output terminal, and the like.

The storage unit 213 is constituted of a storage medium that stores information such as programs and data. For example, the storage unit 213 includes a hard disk, a RAM disk, a nonvolatile memory, and the like. The communication unit 214 is constituted of a communication device that performs communication for exchanging information such as programs and data with external apparatuses via a predetermined communication medium. The communication unit 214 is constituted of, for example, a network interface. For example, the cable 103 is connected to the communication unit 214. The communication unit 214 communicates (exchanges programs and data) with the projection image pickup apparatus 101 via the cable 103.

The drive 215 reads out information (programs, data, etc.) stored in a removable medium 221 loaded therein, examples of the removable medium 221 including a magnetic disk, an optical disc, a magneto-optical disc, and a semiconductor memory. The drive 215 supplies information read out from the removable medium 221 to the CPU 201, the RAM 203, and the like. In a case where a writable removable medium 221 is loaded into the drive 215, the drive 215 is also capable of storing information (programs, data, etc.) supplied from the CPU 201, the RAM 203, and the like in the removable medium 221.

The CPU 201 carries out various types of processing by loading programs stored in the storage unit 213 in the RAM 203 via the input/output interface 210 and the bus 204 and executing them, for example. The RAM 203 also stores data requisite for the CPU 201 to execute the various types of processing, and the like as necessary.

<Configuration of Functional Blocks>

FIG. 11 is a functional block diagram showing an example of main functions realized by the controller 102. As shown in FIG. 11, the controller 102 realizes functional blocks of a correction parameter setting unit 231, an entire-image module selection unit 232, an entire-image control parameter setting unit 233, an attention area setting unit 234, an attention-area module selection unit 235, an attention-area control parameter setting unit 236, an optical system control unit 237, an image processing unit 238, an image projection control unit 239, an image pickup control unit 240, and the like.

The correction parameter setting unit 231 carries out processing related to a setting of correction parameters of projection images projected by the projector modules 121. The entire-image module selection unit 232 carries out processing related to a selection of the projector modules 121 to be used for projecting an entire image (i.e., projection of first images). The entire-image control parameter setting unit 233 carries out processing related to a setting of control parameters of the projector modules involved in the projection of an entire image (i.e., projection of first images).

The attention area setting unit 234 carries out processing related to a setting of attention areas. The attention-area module selection unit 235 carries out processing related to a selection of the projector modules 121 to be used for projecting images with respect to the attention areas (i.e., projection of second images). The attention-area control parameter setting unit 236 carries out processing related to a setting of control parameters of the projector modules involved in the projection of images with respect to the attention areas (i.e., projection of second images).

The optical system control unit 237 carries out processing related to control of the optical system control unit 183 of the projector modules 121 and the optical system control unit 191 of the camera module 122. The image processing unit 238 carries out processing related to control of the image processing unit 152. The image projection control unit 239 carries out processing related to control of the projection unit 181 of the projector modules 121. The image pickup control unit 240 carries out processing related to control of the image pickup unit 193 of the camera module 122.

These functions are realized by the CPU 201 of the controller 102 executing the programs read out from the RAM 203, the storage unit 213, and the like using the RAM 203 and processing data generated by executing the programs or data read out from the RAM 203, the storage unit 213, and the like using the RAM 203.

<Flow of System Control Processing>

An example of a flow of system control processing executed by the controller 102 using these functional blocks will be described with reference to the flowchart shown in FIG. 12.

As the system control processing is started, the correction parameter setting unit 231 sets correction parameters of the projector modules in Step S101. Examples of the correction of projection images of the projector modules 121 include a correction of correcting individual differences of the projector modules (correction etc. on luminance, gamma, brightness, contrast, white balance, tone, etc.), a correction with respect to an overlap area (level correction, distortion correction, etc.), and a correction based on the shape of the image projection surface 111 (projection conversion (flat, spherical, cylindrical, polynomial curve). Of course, the correction contents are arbitrary, and other corrections may be carried out instead. The correction parameter setting unit 231 sets the correction parameters that are parameters used for the corrections as described above (corresponding to correction result).

In Step S102, the entire-image module selection unit 232 selects the projector modules 121 to be allocated to an entire-image projection (i.e., projection of first images) as a projection of images for forming a large projection image. For example, in the case of the example shown in FIG. 8, the projector module 121-1, the projector module 121-3, the projector module 121-6, and the projector module 121-8 are allocated to the entire-image projection for forming a large projection image 131. It should be noted that which projector modules 121 are to be allocated to the entire-image projection is arbitrary, and the projector modules may be allocated in ways different from that shown in FIG. 8. Moreover, how many projector modules 121 are to be allocated to the entire-image projection is also arbitrary, and the number thereof may be different from that shown in FIG. 8.

In Step S103, the entire-image control parameter setting unit 233 sets control parameters used for the optical system control of the projector modules 121 allocated to the entire-image projection and image processing. The entire-image control parameter setting unit 233 sets control parameters for the projector modules 121 allocated to the entire-image projection on the basis of the relative positional relationship of the projector modules 121 allocated to the entire-image projection, a layout pattern of the projection images 112 projected by the projector modules 121, the correction parameters of the projectors set in Step S101, and the like. The control parameters include, for example, control parameters used for control of a projection direction and angle of view, a keystone correction, a blending correction, adjustments of luminance and colors, and the like as shown in FIG. 13. Of course, the control parameters set in this processing are arbitrary and are not limited to the example shown in FIG. 13.

In Step S104, the attention area setting unit 234 sets a part of the entire image (large projection image) as the attention areas. The position, size, and shape of the attention areas are arbitrary. In addition, a method of setting attention areas is also arbitrary. For example, the attention area setting unit 234 may set, using a histogram of first images, areas where a luminance level falls within a desired range (e.g., larger than predetermined reference level) in a large projection image as the attention areas. Moreover, for example, the attention area setting unit 234 may set, using an orthogonal transformation coefficient of first images, areas where a spatial frequency falls within a desired range (e.g., higher frequency than predetermined reference level) in a large projection image as the attention areas. Furthermore, for example, the attention area setting unit 234 may set, using color distributions of first images and the like, areas where the respective color distributions fall within a desired range (e.g., matches predetermined color) in a large projection image as the attention areas. In other words, the attention area setting unit 234 may set areas where a characteristic parameter with respect to the first images falls within a desired range as the attention areas. The characteristic parameter is arbitrary. For example, the characteristic parameter may be the luminance level, spatial frequency, color component, and the like described above or may be other than those. Moreover, the attention areas may be set on the basis of a plurality of characteristic parameters.

Furthermore, for example, the attention area setting unit 234 may detect distances with respect to objects included in the first images (distances in depth direction) and set areas including the objects having distances falling within a desired range (e.g., closer than predetermined reference distance) in a large projection image as the attention areas. Further, for example, the attention area setting unit 234 may carry out a feature detection such as a human detection and a face detection on the first images and set areas where that feature is detected (e.g., areas where person, face, or the like is detected) in a large projection image as the attention areas. Further, for example, the attention area setting unit 234 may carry out a motion detection on the first images and set areas where a motion is detected in a large projection image as the attention areas. Furthermore, for example, the attention area setting unit 234 may exclude areas where a motion is detected from the attention areas.

Further, for example, attention areas including a predetermined object of the first images in a large projection image may be set as the attention areas. For example, in a case where an object included in the first images is identifiable (extractible) as in a CG (Computer Graphics) image, the attention area setting unit 234 may set areas including the identified (extracted) object out of a large projection image as the attention areas. For example, in a case where the first image is configured by a plurality of layers, the attention area setting unit 234 may set areas including an object included in a desired layer out of a large projection image as the attention areas.

Furthermore, for example, the attention area setting unit 234 may set externally-designated areas of a large projection image as the attention areas. For example, the attention area setting unit 234 may set areas designated by a user and the like using a pointer or the like out of a large projection image as the attention areas.

Further, for example, the attention area setting unit 234 may set predetermined portions of a large projection image, that have been set in advance, as the attention areas.

Furthermore, the plurality of methods described above may be used in combination, or the method described above may be used in combination with methods other than those described above.

In Step S105, the attention area setting unit 234 judges whether attention areas exist. When judging that the attention areas have been set by the processing of Step S104 and thus exist, the processing advances to Step S106.

In Step S106, the attention-area module selection unit 235 selects the projector modules 121 to be allocated to the projection of images (second images) in the attention areas set in Step S104. In other words, the attention-area module selection unit 235 selects the projector modules 121 to be allocated to the image projection for forming projection images smaller than the large projection image described above in the attention areas. The attention-area module selection unit 235 selects the projector modules 121 to be allocated to the image projection with respect to the attention areas out of the projector modules 121 excluding those selected in Step S102.

In Step S107, the attention-area control parameter setting unit 236 sets control parameters of the projector modules allocated to the attention areas. The control parameters are similar to those set by the processing of Step S103.

It should be noted that the allocation of the projector modules 121 to the image projection with respect to the attention areas may be prioritized over the allocation of the projector modules 121 to the entire-image projection in Step S102. In this case, for example, the processing of Steps S104 to S107 only need to be carried out before the processing of Steps S102 and S103.

Upon ending the processing of Step S107, the processing advances to Step S108. Also, when judged in Step S105 that attention areas do not exist, the processing advances to Step S108.

In Step S108, the optical system control unit 237 controls the optical system control unit 183 of the projector modules 121 using the control parameters set in Step S103 and the control parameters set in Step S107, to control the image projection direction and angle of view, and the like.

In Step S109, the image projection control unit 239 supplies images to the projector modules 121 and cause them to display the images. Further, the image processing unit 238 controls the image processing unit 152 of the projector modules 121 to carry out image processing as appropriate to correct/edit (process) the images to be projected (first and second images).

In Step S110, the image projection control unit 239 judges whether to end the system control processing. For example, when judging that the system control processing is not to be ended since the image to be projected is a moving image and similar control processing is to be carried out for the next and subsequent frames, the processing returns to Step S102 so that the processing of Step S102 and subsequent steps are repeated for the image of the next frame.

In other words, in the case of projecting a moving image, the processing of Steps S102 to S110 are executed on images of processing target frames. These processing may be carried out on each of the frames of a moving image or may be carried out on partial frames as in every few frames or the like. In other words, the setting of attention areas and the projection of second images in the attention areas may be updated for every frame, updated every multiple frames, updated irregularly, or not updated at all.

When judged in Step S110 that the system control processing is to be ended due to the end of the image projection and the like, the system control processing is ended.

It should be noted that the processing of Step S108 and the processing of Step S109 can be executed in parallel with each other. In other words, while carrying out the image projection, the direction, angle of view, and the like of the image projection can be controlled. In addition, the control of the optical system in Step S108 can be executed in parallel with the processing of Steps S102 to S110. In other words, the control of the optical system in Step S108 can be executed independent from a frame timing of a moving image to be projected. For example, in a case where the processing of Steps S102 to S110 are executed every few frames, the processing of Step S108 may be executed at an arbitrary timing among those few frames.

It should be noted that in the processing described above, a captured image captured by the camera module 122 may be used. For example, in the setting of correction parameters in Step S101, the setting of control parameters in Step S103, the setting of attention areas in Step S104, the setting of control parameters in Step S107, the control processing of Step S108, the control processing of Step S109, and the like, the image pickup control unit 240 may control the respective units of the camera module 122 to capture the projection image 112 on the image projection surface 111 so that the respective processing units can use the captured image.

By executing the system control processing as described above, the projection image pickup system 100 can locally vary the projection image characteristics.

<Example of Projection Image>

Next, an example of projection images obtained by the thus-configured projection image pickup system 100 will be described. In the case of the example shown in FIG. 14A, a large projection image (projection image of first images) is formed by the projection image 112-1, the projection image 112-3, the projection image 112-6, and the projection image 112-8, and an area that includes a person and a motorcycle and is close to the objects within a picture of the large projection image is set as the attention area. In other words, a small projection image (projection image of second images) is formed by the projection image 112-2, the projection image 112-4, the projection image 112-5, and the projection image 112-7. For example, when the projection image 112-2, the projection image 112-4, the projection image 112-5, and the projection image 112-7 have resolutions equivalent to those of the projection image 112-1, the projection image 112-3, the projection image 112-6, and the projection image 112-8, a resolution of the small projection image in the attention area becomes higher than that of images of other areas. Therefore, in the projection image, the person and motorcycle positioned more in the front can be expressed with a high resolution. Moreover, by causing the projection images to overlap one another, luminance of the attention area becomes higher than that of other areas. Therefore, in the projection image, the person and motorcycle positioned more in the front can be expressed more brightly. As a result, the projection images can be displayed such that an attention degree of the attention area (person and motorcycle) naturally becomes higher than that of other areas (i.e., background) (i.e., attract attention in attention area).

In the case of the example shown in FIG. 14B, a large projection image (projection image of first images) is formed by the projection image 112-1, the projection image 112-3, the projection image 112-6, and the projection image 112-8, and areas where motions are detected and that include players and a ball that have been detected as the motions within a picture of the large projection image are set as the attention areas. In other words, small projection images (projection images of second images) are formed by the projection image 112-2, the projection image 112-4, the projection image 112-5, and the projection image 112-7. In this way, a plurality of attention areas can be set with respect to one large projection image.

In the case of the example shown in FIG. 15A, the projection image 112-1 is projected onto a part of a front wall and a part of a ceiling of a room space, the projection image 112-3 is projected onto a part of the front wall and a part of a right-hand side wall of the room space, the projection image 112-6 is projected onto a part of the front wall and a part of a left-hand side wall of the room space, and the projection image 112-8 is projected onto a part of the front wall and a part of a floor of the room space, to thus form a large projection image (projection image of first images) across the parts of the front surface and ceiling, the part of the right-hand side wall, the part of the left-hand side wall, and the part of the floor of the room space. Further, the front wall of the room space is set as the attention area, and the projection image 112-2, the projection image 112-4, the projection image 112-5, and the projection image 112-7 are formed on the front wall. As a result, the image projection range can be widened to the side surfaces, the ceiling, and the floor so as to improve a sense of immersion, and the luminance and resolution of the projection images on the front wall (i.e., main image range) positioned near the center of an eyesight of a user can be raised sufficiently so as to suppress lowering of image quality.

It should be noted that as in the example shown in FIG. 15B, similar projection images can be formed even when the image projection surfaces (walls etc.) are curved surfaces.

By locally raising the luminance, resolution, and the like in this way, an attention degree of a more-important area (attention area) can be improved (made to visually stick out). In other words, it becomes possible to improve image quality only in a more-important area (attention area) and lower image quality (lower luminance and resolution) in other areas that are of no importance (areas excluding attention area). Specifically, since there is no need to improve image quality of the entire projection image, image projection performance requisite for the projection image pickup apparatus 101 can be lowered that much, and the projection image pickup system 100 can be realized at lower costs. Moreover, since areas excluding the attention area can be lowered in image quality, an increase of power consumption requisite for the image projection can be suppressed.

It should be noted that it is also possible to set the image quality of the attention area to be lower than that of other areas. For example, as the second image, an image having a lower resolution than other areas or a blurred image may be projected, an image may be projected while deviating a position thereof, or a gray image or an image subjected to mosaic processing may be projected. It is also possible to lower the attention degree of the attention area in this way. Further, for example, by lowering the image quality in this way when a boundary line is set as the attention area, an anti-aliasing effect can be realized.

Further, an image having a totally different picture from the first image may be projected as the second image in the attention area. For example, as shown in FIG. 16A, a digital image exemplified by a subtitle, a menu screen, and a data screen may be superimposed as a second image 302 on a part of a first image 301. Accordingly, closed captions, on-screen display, and the like can be realized, for example. Also in this case, since the resolution of the second image 302 can be made high as described above, it becomes possible to prevent small characters and the like of the second image 302 from being squashed.

Moreover, as shown in FIG. 16B, for example, a so-called wipe image as a second image 312 may be superimposed on a part of a first image 311. Accordingly, picture-in-picture can be realized, for example. Also in this case, since the resolution of the second image 312 can be made high as described above, it becomes possible to also display small images, that have been impossible to be expressed in a wipe image of the past having a low resolution, more clearly in the second image 312.

Furthermore, by raising the luminance of the attention area, a high dynamic range can also be realized. For example, as shown in FIG. 16C, a light source that looks like the sun in a first image 321 may be set as the attention area, and a second image 322 having high luminance may be superimposed on the attention area. As a result, a contrast ratio between a dark portion of the first image 321 and the second image 322 becomes larger to thus realize a high dynamic range.

Further, by superimposing a second image having a color gamut different from that of the first image on the attention area of the first image, a color gamut of the projection image can be expanded. In the case of the example shown in FIG. 17A, the projector module 121-1 (PJ1) that projects the first image projects an image that has color components having peaks at (R1, G1, B1) in the attention area, and the projector module 121-2 (PJ2) that projects the second image projects an image that has color components having peaks at (R2, G2, B2) onto the same place. As a result, projections of projection images exceeding the image projection performance of the projection image pickup apparatus 101 can be realized.

Further, for example, a high frame rate can be realized by differentiating display timings of the first image and the second image as shown in FIG. 17B. A local high frame rate in particular can be realized. FIG. 17B shows an example of synchronization timings of the projector module 121-1 (PJ1) that projects the first image and synchronization timings of the projector module 121-2 (PJ2) that projects the second image. In the case of this example, since projection timings of the projector modules 121 are deviated by half cycle, the first image and the second image are displayed alternately in the attention area. Therefore, a local high frame rate projection is realized.

It should be noted that at this time, a part of horizontal pixel lines may be thinned out in the first and second images in the attention area. For example, it is possible to project odd-number pixel lines in the first image and project even-number pixel lines in the second image. Alternatively, the pixel lines may be thinned out every multiple lines. Further, for example, vertical pixel lines may be thinned out instead of the horizontal pixel lines. Furthermore, for example, partial areas may be thinned out instead of the horizontal pixel lines.

Further, a stereoscopic image including a parallax may be projected using such a high frame rate. For example, regarding the attention area, it is possible to project a right-eye image as the first image and project a left-eye image as the second image. As a result, a local stereoscopic image projection can be realized.

In other words, the projection timing of the first image and the projection timing of the second image do not need to match. That is, it is possible to project only the second image while controlling its projection position, size, shape, and the like in a state where the first image is not projected. For example, the second image may also be projected while moving.

<Other Configuration Examples of Projection Image Pickup Apparatus>

The configuration of the projection image pickup system 100 is not limited to the example described above. For example, the arrangement of the projector modules of the projection image pickup apparatus 101 is not limited to the example shown in FIG. 2. For example, as shown in FIG. 18A, the camera module 122 does not need to be arranged at the center of the 3-by-3 configuration. Moreover, as shown in FIG. 18B, a plurality of camera modules 122 may be provided. In the case of the example shown in FIG. 18B, the camera module 122-1 and the camera module 122-2 are arranged on both sides of an interruption of the 3-by-3 configuration. By using the plurality of camera modules 122 as described above, it becomes possible to more-easily measure a distance between a captured image and the image projection surface 111 using a parallax of the camera modules 122. Accordingly, the controller 102 can set correction parameters and control parameters more easily and more accurately. Of course, the arrangement position of the camera modules 122 in this case is arbitrary and is not limited to the example shown in FIG. 18B.

In addition, the module configuration of the projection image pickup apparatus 101 is arbitrary and is not limited to 3-by-3. For example, as in the example shown in FIG. 18C, it is also possible for the projection image pickup apparatus 101 to include the projector module 121-1, the camera module 122, and the projector module 121-2 arranged in a 1 (longitudinal direction)-by-3 (lateral direction) configuration. Alternatively, for example, as in the example shown in FIG. 18D, the modules may form a 3 (longitudinal direction)-by-1 (lateral direction) configuration. Alternatively, as in the example shown in FIG. 18E, it is possible for the projection image pickup apparatus 101 to include 10 projector modules 121-1 and two camera modules 122 that are arranged in a 3 (longitudinal direction)-by-4 (lateral direction) configuration.

Alternatively, as in the example shown in FIG. 18F, the modules may be arranged apart from one another. In this case, for example, the relative positions may be fixed by fixing members or the like (not shown), or the modules may be arranged independent from one another.

Further, although the control unit 151 or the like common to the modules is provided in the projection image pickup apparatus 101 in the example shown in FIG. 9, the modules may operate independent from one another.

A main configuration example of the projector modules 121 in this case is shown in FIG. 19. In the case of the example shown in FIG. 19, the projector module 121 includes a control unit 351, an image processing unit 352, a memory 353, a projection unit 354, an optical system 355, an optical system control unit 356, an input unit 361, an output unit 362, a storage unit 363, a communication unit 364, and a drive 365.

The control unit 351 is a processing unit similar to the control unit 151. The image processing unit 352 is a processing unit similar to the image processing unit 152. The memory 353 is a processing unit similar to the memory 153. The projection unit 354 is a processing unit similar to the projection unit 181. The optical system 355 is a processing unit similar to the optical system 182. The optical system control unit 356 is a processing unit similar to the optical system control unit 183. The input unit 361 is a processing unit similar to the input unit 161. The output unit 362 is a processing unit similar to the output unit 162. The storage unit 363 is a processing unit similar to the storage unit 163. The communication unit 364 is a processing unit similar to the communication unit 164. The drive 365 is a processing unit similar to the drive 165, and a removable medium 371 similar to the removable medium 171 can be loaded therein.

In other words, the processing units of the control unit 351 to the drive 365 carry out processing similar to those of the corresponding processing units shown in FIG. 9. However, the processing units shown in FIG. 19 do not carry out control processing regarding image pickup or image processing on a captured image.

Further, a main configuration example of the camera module 122 in this case is shown in FIG. 20. In the case of the example shown in FIG. 20, the camera module 122 includes a control unit 401, an optical system control unit 402, an optical system 403, an image pickup unit 404, an image processing unit 405, a memory 406, an input unit 411, an output unit 412, a storage unit 413, a communication unit 414, and a drive 415.

The control unit 401 is a processing unit similar to the control unit 151. The optical system control unit 402 is a processing unit similar to the optical system control unit 191. The optical system 403 is a processing unit similar to the optical system 192. The image pickup unit 404 is a processing unit similar to the image pickup unit 193. The image processing unit 405 is a processing unit similar to the image processing unit 152. The memory 406 is a processing unit similar to the memory 153. The input unit 411 is a processing unit similar to the input unit 161. The output unit 412 is a processing unit similar to the output unit 162. The storage unit 413 is a processing unit similar to the storage unit 163. The communication unit 414 is a processing unit similar to the communication unit 164. The drive 415 is a processing unit similar to the drive 165, and a removable medium 421 similar to the removable medium 171 can be loaded therein.

In other words, the processing units of the control unit 401 to the drive 415 carry out processing similar to those of the corresponding processing units shown in FIG. 9. However, the processing units shown in FIG. 20 do not carry out control processing regarding projections or image processing on an image to be projected.

By providing the control unit in each of the projector modules 121 and the camera module 122 as described above, the modules are capable of operating independently from one another.

<Other Configuration Examples of Projection Image Pickup System>

Although the projection image pickup apparatus 101 and the controller 102 communicate with each other via the cable 103 in FIG. 1, the projection image pickup apparatus 101 and the controller 102 may communicate wirelessly. In this case, the cable 103 can be omitted. Also in this case, the communication unit 164 (communication unit 364) and the communication unit 214 (communication unit 414) are capable of performing wireless communication using a wireless LAN (Local Area Network), Bluetooth (registered trademark), IrDA (registered trademark), and the like. Of course, these communication units may be capable of performing both wired communication and wireless communication.

Further, although the projection image pickup apparatus 101 and the controller 102 are configured separately in FIG. 1, the present technology is not limited thereto, and the projection image pickup apparatus 101 and the controller 102 may be formed integrally as shown in FIG. 21A. A projection image pickup apparatus 431 shown in FIG. 21A is an apparatus in which the projector modules 121 and camera module 122 of the projection image pickup apparatus 101 and the controller 102 are integrated and includes functions similar to those of the projection image pickup system 100 shown in FIG. 1.

Alternatively, as shown in FIG. 21B, the projection image pickup apparatus 101 and the controller 102 may be connected via a predetermined network 441. The network 441 is a communication network as a communication medium. The network 441 may be any communication network and may be a wired communication network, a wireless communication network, or both of them. For example, a wired LAN, a wireless LAN, a public telephone network, a wide area communication network for wireless mobile objects, such as a so-called 3G line and 4G line, the Internet, or the like may be used, or a combination of those may also be used. Moreover, the network 441 may be a single communication network or a plurality of communication networks. In addition, a part or all of the network 441 may be configured by a communication cable of a predetermined standard, such as a USB cable and an HDMI cable (registered trademark), for example.

Furthermore, as shown in FIG. 21C, it is also possible for the modules of the projection image pickup apparatus 101 to operate independently, the controller 102 to be omitted, and processing similar to that of the controller 102 to be carried out in any of the modules. In the case of the example shown in FIG. 21C, the projector modules 121-1 to 121-8 and the camera module 122 operate independent from one another, and the modules are connected while being capable of communicating with one another via the network 441. Of these modules, the projector module 121-8 becomes a master to carry out processing similar to that of the controller 102 and control other modules. It should be noted that the modules may be formed integrally, or each of the modules may be configured as one apparatus.

It should be noted although the projection image pickup system 100 includes one projection image pickup apparatus 101 and one controller 102 in FIG. 1, the number of projection image pickup apparatuses 101 and the number of controllers 102 are arbitrary and may be multiple.

Further, although images projected by the projection image pickup apparatus 101 (first images and second images) are provided by the controller 102 in the descriptions above, a provision source of the images (first images and second images) is arbitrary and may be other than the controller 102. For example, the images may be supplied from an apparatus other than the projection image pickup apparatus 101 and the controller 102, like a content server, or the projection image pickup apparatus 101 may store content data in advance.

<Other Configuration Examples of Projection Unit>

The projection unit 181 may use laser light as a light source. A main configuration example of the projection unit 181 in this case is shown in FIG. 22. In FIG. 22, the projection unit 181 includes a video processor 451, a laser driver 452, a laser output unit 453-1, a laser output unit 453-2, a laser output unit 453-3, a mirror 454-1, a mirror 454-2, a mirror 454-3, an MEMS (Micro Electro Mechanical Systems) driver 455, and a MEMS mirror 456.

The video processor 451 stores an image supplied from the image processing unit 152 and carries out requisite image processing on that image. The video processor 451 supplies that image to be projected to the laser driver 452 and the MEMS driver 455.

The laser driver 452 controls the laser output units 453-1 to 453-3 to project images supplied from the video processor 451. The laser output units 453-1 to 453-3 output laser light of mutually-different colors (wavelength ranges) such as red, blue, and green. In other words, the laser driver 452 controls laser outputs of respective colors so as to project an image supplied from the video processor 451. It should be noted that the laser output units 453-1 to 453-3 will be referred to as laser output units 453 unless it is necessary to distinguish them from one another.

The mirror 454-1 reflects laser light output from the laser output unit 453-1 and guides it to the MEMS mirror 456. The mirror 454-2 reflects laser light output from the laser output unit 453-2 and guides it to the MEMS mirror 456. The mirror 454-3 reflects laser light output from the laser output unit 453-3 and guides it to the MEMS mirror 456. It should be noted that the mirrors 454-1 to 454-3 will be referred to as mirrors 454 unless it is necessary to distinguish them from one another.

The MEMS driver 455 controls drive of the mirror of the MEMS mirror 456 so as to project an image supplied from the video processor 451. The MEMS mirror 456 drives a mirror attached to MEMS under control of the MEMS driver 455 to scan the laser light of the respective colors as in the example shown in FIG. 23, for example. The laser light is output from the light-emitting portion 121A to outside the apparatus to be irradiated onto the image projection surface 111, for example. Accordingly, the image supplied from the video processor 451 is projected onto the image projection surface 111.

It should be noted that although 3 laser output units 453 are provided so as to output laser light of 3 colors in the example shown in FIG. 22, the number of laser light beams (or number of colors) is arbitrary. For example, 4 or more laser output units 453 may be provided, or the number may be 2 or less. In other words, laser light output from the projection image pickup apparatus 101 (projection unit 181) may be two beams or less or may be 4 beams or more. In addition, the number of colors of laser light output from the projection image pickup apparatus 101 (projection unit 181) is also arbitrary and may be two colors or less or 4 colors or more. Moreover, the configurations of the mirrors 454 and the MEMS mirror 456 are also arbitrary and are not limited to the example shown in FIG. 22. Of course, the laser light scanning pattern is arbitrary.

<Synchronization Among Projector Modules>

In the case of such a projection unit 181 that uses MEMS, since MEMS carries out an oscillation operation of a device, the modules of the projection image pickup apparatus 101 cannot be driven by external synchronization signals. If not synchronized accurately among the modules, there is a fear that a video blur or residual image will be caused to thus lower image quality of a projection image.

In this regard, as shown in FIG. 24, for example, the controller 102 may acquire synchronization signals (horizontal synchronization signals and vertical synchronization signals) from the projector modules 121 and control the projector modules to project the first images and second images at timings where the synchronization signals (e.g., vertical synchronization signals) of all the projector modules 121 match.

<Flow of Projector Module Control Processing>

An example of a flow of projector module control processing executed by the controller 102 in this case will be described with reference to the flowchart of FIG. 25.

As the projector module control processing is started, the image processing unit 238 acquires image data of a new frame from an external apparatus in sync with external synchronization signals in Step S131. In Step S132, the image processing unit 238 stores the image data of a new frame acquired in Step S131 in the storage unit 213 and the like.

In Step S133, the image projection control unit 239 acquires horizontal or vertical synchronization signals from the projector modules 121 and judges whether synchronization timings of all the projector modules 121 have matched. When judged that the timings have matched, the processing advances to Step S134.

In Step S134, the image projection control unit 239 reads out image data of a new frame from the storage unit 213 at a timing corresponding to that synchronization timing and supplies the image data of a new frame to the projector modules 121 that is to project the image data of a new frame. In Step S135, the image projection control unit 239 causes the projector modules 121 to project the supplied image of a new frame at the timing corresponding to that synchronization timing. Upon ending the processing of Step S135, the processing advances to Step S137.

Further, when judged in Step S133 that synchronization signals of all the projector modules have not been detected, the processing advances to Step S136. In Step S136, the image projection control unit 239 causes the projector modules 121 to project an image of a current frame at the timing corresponding to that synchronization timing. Upon ending the processing of Step S136, the processing advances to Step S137.

In Step S137, the image projection control unit 239 judges whether to end the projector module control processing. When judged as not ending since the projection of a moving image is continuing, the processing returns to Step S131, and the processing of that step and subsequent steps are executed for the new frame.

On the other hand, when judged in Step S137 as ending the projector module control processing since the projection of all frames has ended, for example, the projector module control processing is ended.

By executing the projector module control processing in this way, the controller 102 can cause the projector modules 121 to project an image at the same timing, with the result that lowering of image quality of a projection image due to a video blur, residual image, and the like can be suppressed.

<Synchronization Among Projector Modules and Camera Module>

Further, in the case of such a projection unit 181 that uses MEMS, the controller 102 may control the modules such that the camera module 122 captures an image at a timing corresponding to a synchronization signal (horizontal synchronization signal or vertical synchronization signal) generated by any one of the projector modules 121 as shown in FIG. 24, for example.

For example, if the image projection timing of the projector modules 121 and the image pickup timing of the camera module 122 are deviated, there is a fear that it will become difficult to capture a projection image.

In this regard, in the case of the example shown in FIG. 24, an OR gate 461 that is input with vertical synchronization signals generated by the projector modules 121 is provided, and outputs of the OR gate 461 are supplied to the camera module 122 as vertical synchronization signals. Therefore, the camera module 122 can capture an image at a timing corresponding to the synchronization timing of any one of the projector modules 121.

<Flow of Camera Module Control Processing>

An example of a flow of camera module control processing executed by the controller 102 in this case will be described with reference to the flowchart of FIG. 26.

As the camera module control processing is started, the image pickup control unit 240 acquires horizontal or vertical synchronization signals from the projector modules 121 and judges whether it has matched with the synchronization timing of any of the projector modules 121 in Step S151. When judged as matched, the processing advances to Step S152.

In Step S152, the image pickup control unit 240 controls the camera module 122 to capture an image and take in the captured image at a timing corresponding to that synchronization timing. In Step S153, the image pickup control unit 240 acquires the captured image data that has been taken in, from the camera module 122.

In Step S154, the image processing unit 238 stores the acquired captured image data in the storage unit 213 and the like. Upon ending the processing of Step S154, the processing advances to Step S155. On the other hand, when judged in Step S151 as not matching with the synchronization timing of any of the projector modules 121, the processing advances to Step S155.

In Step S155, the image processing unit 238 judges whether to end the camera module control processing. When judged as not ending since the projection of a moving image is continuing, the processing returns to Step S151, and the processing of that step and subsequent steps are executed for the new frame.

On the other hand, when judged in Step S155 as ending the camera module control processing since the projection of all frames has ended, for example, the camera module control processing is ended.

By executing the camera module control processing in this way, the controller 102 can cause an image to be captured at a timing corresponding to the projection timing of the projector modules 121, and a captured image including a projection image can be obtained more accurately. Accordingly, the processing that uses a captured image (e.g., parameter setting, attention area detection, etc.) in the system control processing can be executed more appropriately.

<Setting of Attention Area>

Further, since an image projection is carried out by scanning laser light in the case of the projection unit 181 that uses MEMS, the attention area can be set in shapes other than a rectangle. In this regard, as in the example shown in FIG. 27, the attention areas may be set by dividing and integrating areas according to a predetermined image characteristic (e.g., luminance, spatial frequency, etc.) in a first image. In the case of the example shown in FIG. 27, the attention area setting unit 234 divides an area where the predetermined image characteristic is non-uniform (not sufficiently uniform) and recursively repeats this division until the image characteristic becomes sufficiently uniform in all areas. Further, in a case where the image characteristics of adjacent areas match or are sufficiently approximate to each other, the attention area setting unit 234 integrates those areas. In other words, in a case where the image characteristic is sufficiently uniform in the integrated areas, the attention area setting unit 234 integrates those adjacent areas.

In this way, the attention area setting unit 234 divides the area of the first image such that a predetermined image characteristic becomes sufficiently uniform in the area and the image characteristics do not match (are not sufficiently approximate) among adjacent areas. Then, the attention area setting unit 234 sets an area where the image characteristic thereof is within a desired range out of the divided areas as the attention area.

<Flow of Attention Area Setting Processing>

An example of a flow of attention area setting processing in this case will be described with reference to the flowchart of FIG. 28. As the attention area setting processing is started, the attention area setting unit 234 divides an area where a predetermined image characteristic is non-uniform (not sufficiently uniform) in Step S171 (e.g., divides into 4 areas (2×2)).

In Step S172, the attention area setting unit 234 judges whether that image characteristic has become sufficiently uniform in all areas obtained by the division. When judged that there is an area where that image characteristic is not sufficiently uniform, the processing returns to Step S171 so that the area division is carried out on that area.

When judged in Step S172 that the image characteristic has become sufficiently uniform in all areas obtained by the division, the processing advances to Step S173.

In Step S173, the attention area setting unit 234 integrates adjacent areas where that image characteristics match (or are sufficiently approximate).

In Step S174, the attention area setting unit 234 judges whether that image characteristics differ (are not sufficiently approximate) among all the adjacent areas. When judged that there are adjacent areas where that image characteristics match (or are sufficiently approximate), the processing returns to Step S173 so as to integrate the adjacent areas where that image characteristics match (or are sufficiently approximate).

When judged in Step S174 that the image characteristics differ (are not sufficiently approximate) among all the adjacent areas, the processing advances to Step S175.

In Step S175, the attention area setting unit 234 sets an area where that image characteristic is within a desired range out of the thus-set areas obtained by the division as the attention area.

Upon ending the processing of Step S175, the attention area setting processing is ended.

By setting the attention area in this way, the attention area setting unit 234 can set an attention area having a more-uniform image characteristic.

The series of processing described above can be executed either by hardware or software. In a case where the series of processing described above is executed by software, programs configuring the software are installed from a network or a recording medium.

As shown in FIGS. 9, 10, 19, 20, and the like, for example, the recording medium is constituted of the removable medium 171, the removable medium 221, the removable medium 371, the removable medium 421, and the like on which programs are recorded, the removable media being distributed for delivering the programs to users and provided separate from the apparatus body. These removable media include a magnetic disk (including flexible disk) and an optical disc (including CD-ROM and DVD) and also a magneto-optical disc (including MD (Mini Disc)), a semiconductor memory, and the like.

In this case, in the projection image pickup apparatus 101, for example, the programs can be installed in the storage unit 163 by loading the removable medium 171 in the drive 165. Moreover, in the controller 102, for example, the programs can be installed in the storage unit 213 by loading the removable medium 221 in the drive 215. Further, in the projector module 121, for example, the programs can be installed in the storage unit 363 by loading the removable medium 371 in the drive 365. Furthermore, in the camera module 122, for example, the programs can be installed in the storage unit 413 by loading the removable medium 421 in the drive 415.

Furthermore, the programs can also be provided via a wired or wireless transmission medium such as a local area network, the Internet, and digital satellite broadcasting. In this case, in the projection image pickup apparatus 101, for example, the programs can be received by the communication unit 164 and installed in the storage unit 163. Further, in the controller 102, for example, the programs can be received by the communication unit 214 and installed in the storage unit 213. Further, in the projector module 121, for example, the programs can be received by the communication unit 364 and installed in the storage unit 363. Furthermore, in the camera module 122, for example, the programs can be received by the communication unit 414 and installed in the storage unit 413.

Alternatively, it is also possible to install the programs in advance in the storage unit, the ROM, and the like. In the case of the projection image pickup apparatus 101, for example, the programs can be installed in advance in the storage unit 163, the ROM incorporated into the control unit 151, and the like. Further, in the case of the controller 102, for example, the programs can be installed in advance in the storage unit 213, the ROM 202, and the like. Further, in the case of the projector module 121, for example, the programs can be installed in advance in the storage unit 363, the ROM incorporated into the control unit 351, and the like. Furthermore, in the case of the camera module 122, for example, the programs can be installed in advance in the storage unit 413, the ROM incorporated into the control unit 401, and the like.

It should be noted that the programs executed by a computer may be programs in which processing are carried out in time series in the order described in the specification or may be programs in which processing are carried out in parallel or at necessary timings such as when invoked.

Further, in the specification, the steps describing the programs recorded onto the recording media include not only processing that are carried out in time series in the stated order but also processing that are executed in parallel or individually even when not necessarily executed in time series.

Moreover, the processing of the steps described above can be executed in the respective apparatuses described above or arbitrary apparatuses other than the apparatuses described above. In this case, the apparatus that executes the processing only needs to include the functions described above that are requisite for executing that processing (functional blocks etc.). Moreover, information requisite for the processing only needs to be transmitted to that apparatus as appropriate.

Further, in the specification, the system refers to an aggregation of a plurality of constituent elements (apparatuses, modules (components), etc.), and whether all the constituent elements are provided within the same casing is irrelevant. Therefore, a plurality of apparatuses that are accommodated in different casings and connected via a network and a single apparatus in which a plurality of modules are accommodated in a single casing are both referred to as system.

Furthermore, the configuration described as a single apparatus (or processing unit) above may be divided to configure a plurality of apparatuses (or processing units). Conversely, the configurations described as a plurality of apparatuses (or processing units) above may be integrated as a single apparatus (or processing unit). Moreover, configurations that are not described above may of course be added to the configurations of the respective apparatuses (or processing units). Furthermore, as long as the configurations and operations as the entire system are substantially the same, a part of a configuration of a certain apparatus (or processing unit) may be included in a configuration of another apparatus (or processing unit).

Heretofore, a favorable embodiment of the present disclosure has been specifically described with reference to the attached drawings, but the technical range of the present disclosure is not limited to the examples above. It should be understood by those skilled in the art that various modifications, combinations, sub-combinations and alterations may occur depending on design requirements and other factors insofar as they are within the scope of the appended claims or the equivalents thereof.

For example, the present technology can take a cloud computing configuration in which one function is divided and processed in cooperation by a plurality of apparatuses via a network.

Further, the steps described in the flowcharts above can be executed by a single apparatus or can be divided and executed by a plurality of apparatuses.

Furthermore, in a case where a plurality of processing are included in a single step, the plurality of processing included in that single step can be executed by a single apparatus or can be divided and executed by a plurality of apparatuses.

Furthermore, the present technology is not limited thereto and can be embodied as various configurations mounted on such an apparatus or apparatuses configuring a system, such as a processor as a system LSI (Large Scale Integration) and the like, a module that uses a plurality of processors and the like, a unit that uses a plurality of modules and the like, and a set in which other functions are added to the unit (i.e., partial configuration of apparatus).

It should be noted that the present technology can also take the following configurations.
(1) An information processing apparatus, including

a control unit that controls a first projection unit to project a first image onto an image projection surface and controls a second projection unit to project the second image in an attention area as a predetermined partial area of the first image projected onto the image projection surface by the first projection unit.
(2) The information processing apparatus according to (1), in which

the control unit causes a partial image projected in the attention area of the first image or an image obtained by changing parameters of the partial image, to be projected as the second image in the attention area.
(3) The information processing apparatus according to (1) or (2), in which

the control unit causes an image having a picture different from that of a partial image projected in the attention area of the first image, to be projected as the second image in the attention area.
(4) The information processing apparatus according to any one of (1) to (3), further including

an attention area setting unit that sets the attention area,

in which the control unit controls a direction and angle of view of the projection of the second projection unit to cause the second image to be projected in the attention area set by the attention area setting unit.
(5) The information processing apparatus according to (4), in which

the attention area setting unit sets the attention area on the basis of a predetermined image characteristic.
(6) The information processing apparatus according to (5), in which

the attention area setting unit sets, as the attention area, an area where a characteristic parameter with respect to the first image is within a desired range.
(7) The information processing apparatus according to (5) or (6), in which

the attention area setting unit sets, as the attention area, an area including an object whose distance from the first image in a depth direction is within a desired range.
(8) The information processing apparatus according to any one of (5) to (7), in which

the attention area setting unit sets an area where a feature is detected with respect to the first image as the attention area.
(9) The information processing apparatus according to any one of (4) to (8), in which

the attention area setting unit sets an area including an object with respect to the first image as the attention area.
(10) The information processing apparatus according to any one of (4) to (9), in which

the attention area setting unit sets an area designated with respect to the first image as the attention area.
(11) The information processing apparatus according to any one of (4) to (10), in which

the control unit controls the direction and angle of view of the projection of the second projection unit on the basis of a captured image obtained by an image pickup unit capturing the first image and the second image projected onto the image projection surface.
(12) The information processing apparatus according to any one of (1) to (11), in which

the first projection unit and the second projection unit are driven in sync with synchronization signals that are independent from each other, and

the control unit causes the first image and the second image to be projected at a timing where the synchronization signals of all the projection units match.
(13) The information processing apparatus according to any one of (1) to (12), further including

an attention area setting unit that sets the attention area,

in which

the first projection unit and the second projection unit are driven in sync with synchronization signals that are independent from each other, and

the control unit controls an image pickup unit to capture the first image and the second image projected onto the image projection surface in sync with the synchronization signals and controls a direction and angle of view of the projection of the second projection unit on the basis of the captured image, to cause the second image to be projected in the attention area set by the attention area setting unit.
(14) The information processing apparatus according to any one of (1) to (13), further including

the first projection unit, and

the second projection unit.
(15) The information processing apparatus according to (14), in which

a relative position between the first projection unit and the second projection unit is fixed.
(16) The information processing apparatus according to (15), further including

an image pickup unit that captures the first image and the second image projected onto the image projection surface.
(17) The information processing apparatus according to (16), in which

the first projection unit, the second projection unit, the image pickup unit, and the control unit are formed integrally.
(18) The information processing apparatus according to (17), in which

the first projection unit and the second projection unit are arranged in a periphery of the image pickup unit.
(19) The information processing apparatus according to any one of (16) to (18), in which

the image pickup unit is provided plurally.
(20) An information processing method, including:

controlling a first projection unit to project a first image onto an image projection surface; and

controlling a second projection unit to project the second image in an attention area as a predetermined partial area of the first image projected onto the image projection surface by the first projection unit.

### REFERENCE SIGNS LIST

100 projection image pickup system
101 projection image pickup apparatus
102 controller
111 image projection surface
112 projection image
121 projector module
122 camera module
131 projection image
151 control unit
152 image processing unit
153 memory
161 input unit
162 output unit
163 storage unit
164 communication unit
165 drive
171 removable medium
181 projection unit
182 optical system
183 optical system control unit
191 optical system control unit
192 optical system
193 image pickup unit
201 CPU
202 ROM
203 RAM
204 bus
210 input/output interface
211 input unit
212 output unit
213 storage unit
214 communication unit
215 drive
221 removable medium
231 correction parameter setting unit
232 entire-image module selection unit
233 entire-image control parameter setting unit
234 attention area setting unit
235 attention-area module selection unit
236 attention-area control parameter setting unit
237 optical system control unit
238 image processing unit
239 image projection control unit
240 image pickup control unit
351 control unit
352 image processing unit
353 memory
354 projection unit
355 optical system
356 optical system control unit
361 input unit
362 output unit
363 storage unit
364 communication unit
365 drive
371 removable medium
401 control unit
402 optical system control unit
403 optical system
404 image pickup unit
405 image processing unit
406 memory
411 input unit
412 output unit
413 storage unit
414 communication unit
415 drive
421 removable medium
431 projection image pickup apparatus
441 network
451 video processor
452 laser driver
453 laser output unit
454 mirror
455 MEMS driver
456 MEMS mirror
461 OR gate

1. An information processing apparatus, comprising
a control unit that controls a first projection unit to project a first image onto an image projection surface and controls a second projection unit to project the second image in an attention area as a predetermined partial area of the first image projected onto the image projection surface by the first projection unit.

2. The information processing apparatus according to claim 1, wherein
the control unit causes a partial image projected in the attention area of the first image or an image obtained by changing parameters of the partial image, to be projected as the second image in the attention area.

3. The information processing apparatus according to claim 1, wherein
the control unit causes an image having a picture different from that of a partial image projected in the attention area of the first image, to be projected as the second image in the attention area.

4. The information processing apparatus according to claim 1, further comprising
an attention area setting unit that sets the attention area,
wherein the control unit controls a direction and angle of view of the projection of the second projection unit to cause the second image to be projected in the attention area set by the attention area setting unit.

5. The information processing apparatus according to claim 4, wherein
the attention area setting unit sets the attention area on the basis of a predetermined image characteristic.

6. The information processing apparatus according to claim 5, wherein
the attention area setting unit sets, as the attention area, an area where a characteristic parameter with respect to the first image is within a desired range.

7. The information processing apparatus according to claim 5, wherein
the attention area setting unit sets, as the attention area, an area including an object whose distance from the first image in a depth direction is within a desired range.

8. The information processing apparatus according to claim 5, wherein
the attention area setting unit sets an area where a feature is detected with respect to the first image as the attention area.

9. The information processing apparatus according to claim 4, wherein
the attention area setting unit sets an area including an object with respect to the first image as the attention area.

10. The information processing apparatus according to claim 4, wherein
the attention area setting unit sets an area designated with respect to the first image as the attention area.

11. The information processing apparatus according to claim 4, wherein
the control unit controls the direction and angle of view of the projection of the second projection unit on the basis of a captured image obtained by an image pickup unit capturing the first image and the second image projected onto the image projection surface.

12. The information processing apparatus according to claim 1, wherein
the first projection unit and the second projection unit are driven in sync with synchronization signals that are independent from each other, and
the control unit causes the first image and the second image to be projected at a timing where the synchronization signals of all the projection units match.

13. The information processing apparatus according to claim 1, further comprising
an attention area setting unit that sets the attention area,
wherein
the first projection unit and the second projection unit are driven in sync with synchronization signals that are independent from each other, and
the control unit controls an image pickup unit to capture the first image and the second image projected onto the image projection surface in sync with the synchronization signals and controls a direction and angle of view of the projection of the second projection unit on the basis of the captured image, to cause the second image to be projected in the attention area set by the attention area setting unit.

14. The information processing apparatus according to claim 1, further comprising
the first projection unit, and
the second projection unit.

15. The information processing apparatus according to claim 14, wherein
a relative position between the first projection unit and the second projection unit is fixed.

16. The information processing apparatus according to claim 15, further comprising
an image pickup unit that captures the first image and the second image projected onto the image projection surface.

17. The information processing apparatus according to claim 16, wherein
the first projection unit, the second projection unit, the image pickup unit, and the control unit are formed integrally.

18. The information processing apparatus according to claim 17, wherein
the first projection unit and the second projection unit are arranged in a periphery of the image pickup unit.

19. The information processing apparatus according to claim 16, wherein
the image pickup unit is provided plurally.

20. An information processing method, comprising:
controlling a first projection unit to project a first image onto an image projection surface; and
controlling a second projection unit to project the second image in an attention area as a predetermined partial area of the first image projected onto the image projection surface by the first projection unit.
